(19) United States
(12) Patent Application Publication
(10) Pub. No.: US 2026/0012895 A1
(43) Pub. Date: Jan. 8, 2026

(54) METHOD AND DEVICE FOR MULTI-TRANSMISSION AND RECEPTION POINT OPERATIONS

(71) Applicant: SHARP KABUSHIKI KAISHA, Sakai City, Osaka (JP)

(72) Inventors: MEI-JU SHIH, Taipei (TW); CHIA-HUNG LIN, Taipei (TW); WAN-CHEN LIN, Taipei (TW)

(21) Appl. No.: 18/992,790

(22) PCT Filed: Jul. 14, 2023
(86) PCT No.: PCT/CN2023/107424

§ 371 Date: Jan. 9, 2025

Related U.S. Application Data
(60) Provisional application No. 63/390,525, filed on Jul. 19, 2022.

(51) Int. Cl. H04W 52/14; H04L 5/00

(52) U.S. Cl. CPC H04W 52/146; H04L 5/0044

(57) ABSTRACT

Methods and devices for multi-Transmission and Reception Point (mTRP) operations are provided. A method performed by a User Equipment (UE) includes applying a first Transmission Configuration Indication (TCI) state and a first Uplink (UL) power control configuration, which are associated with a first TRP, to perform a first UL transmission toward the first TRP; and applying a second TCI state and a second UL power control configuration, which are associated with the second TRP, to perform a second UL transmission toward the second TRP.

### FIELD

The present disclosure generally relates to wireless communications and, more particularly, to methods and devices for multi-Transmission and Reception Point (mTRP) operations.

### BACKGROUND

With the tremendous growth in the number of connected devices and the rapid increase in user/network traffic volume, various efforts have been made to improve different aspects of wireless communication for next-generation wireless communication systems, such as fifth-generation (5G) New Radio (NR), by improving data rate, latency, reliability, and mobility.

The 5G NR system is designed to provide flexibility and configurability to optimize network services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communications in next-generation wireless communication systems.

### SUMMARY

The present disclosure is directed to methods and devices for multi-Transmission and Reception Point (mTRP) operations.

According to a first aspect of the present disclosure, a method performed by a User Equipment (UE) for multi-Transmission and Reception Point (mTRP) operations to communicate with a plurality of Transmission and Reception Points (TRPs) including a first TRP and a second TRP is provided. The method includes applying a first Transmission Configuration Indication (TCI) state and a first Uplink (UL) power control configuration, which are associated with the first TRP, to perform a first UL transmission toward the first TRP; and applying a second TCI state and a second UL power control configuration, which are associated with the second TRP, to perform a second UL transmission toward the second TRP.

In some implementations of the first aspect of the present disclosure, the method further includes receiving a Radio Resource Control (RRC) message from the first TRP, the RRC message including a set of UL power control configurations associated with the second TRP, the set of UL power control configurations including the second UL power control configuration; and receiving a Medium Access Control (MAC) Control Element (CE) from one of the first TRP and the second TRP, the MAC CE indicating to the UE to apply the second UL power control configuration among the set of UL power control configurations to perform the second UL transmission.

In some implementations of the first aspect of the present disclosure, the method further includes indicating to a lower layer of a MAC layer of the UE information regarding the MAC CE.

In some implementations of the first aspect of the present disclosure, the MAC CE includes at least one of a serving cell Identity (ID) of a serving cell associated with the second TRP, a power control configuration ID of the second UL power control configuration, or a TCI state ID of the second TCI state.

In some implementations of the first aspect of the present disclosure, the MAC CE is received from the second TRP.

In some implementations of the first aspect of the present disclosure, the method further includes receiving first unified TCI state type indication of a type of the first TCI state; and receiving second unified TCI state type indication of a type of the second TCI state, wherein each of the type of the first TCI state and the type of the second TCI state is one of an UL TCI state and a joint TCI state.

In some implementations of the first aspect of the present disclosure, the method further includes determining a first UL transmission power for the first UL transmission according to the first UL power control configuration; determining a second UL transmission power for the second UL transmission according to the second UL power control configuration; using the first UL transmission power to transmit a first set of UL resources toward the first TRP; and using the second UL transmission power to transmit a second set of UL resources toward the second TRP.

In some implementations of the first aspect of the present disclosure, the first set of UL resources includes a first Physical Uplink Control Channel (PUCCH), a first Physical Uplink Shared Channel (PUSCH), and a first Sounding Reference Signal (SRS), and the second set of UL resources includes a second PUCCH, a second PUSCH, and a second SRS.

In some implementations of the first aspect of the present disclosure, the first TRP is associated with a source serving cell and the second TRP is associated with a target serving cell.

In some implementations of the first aspect of the present disclosure, the first TRP and the second TRP are associated with a same serving cell.

In some implementations of the first aspect of the present disclosure, the first UL power control configuration is associated with at least one of the first TCI state, a first TCI state Identity (ID) of the first TCI state, a first panel ID associated with the first TRP, a first cell ID associated with the first TRP, a first search space ID associated with the first TRP, a first Control Resource Set (CORESET) ID associated with the first TRP, a first CORESET pool index associated with the first TRP, or a first TRP-specific ID associated with the first TRP. The second UL power control configuration is associated with at least one of the second TCI state, a second TCI state ID of the second TCI state, a second panel ID associated with the second TRP, a second cell ID associated with the second TRP, a second search space ID associated with the second TRP, a second CORESET ID associated with the second TRP, a second CORESET pool index associated with the second TRP, or a second TRP-specific ID associated with the second TRP.

In some implementations of the first aspect of the present disclosure, the first UL power control configuration includes at least one of a first UL power control ID associated with the first TRP, a first P0 alpha set configuration for a first Physical Uplink Control Channel (PUCCH) associated with the first TRP, a second P0 alpha set configuration for a first Physical Uplink Shared Channel (PUSCH) associated with the first TRP, or a third P0 alpha set configuration for a first Sounding Reference Signal (SRS) associated with the first TRP. The second UL power control configuration includes at least one of a second UL power control ID associated with the second TRP, a fourth P0 alpha set configuration for a second PUCCH associated with the second TRP, a fifth P0 alpha set configuration for a second PUSCH associated with the second TRP, or a sixth P0 alpha set configuration for a second SRS associated with the second TRP.

In some implementations of the first aspect of the present disclosure, the first P0 alpha set configuration is the same as the fourth P0 alpha set configuration, the second P0 alpha set configuration is the same as the fifth P0 alpha set configuration, and the third P0 alpha set configuration is the same as the sixth P0 alpha set configuration.

According to a second aspect of the present disclosure, a User Equipment (UE) for performing multi-Transmission and Reception Point (mTRP) operations to communicate with a plurality of Transmission and Reception Points (TRPs) including a first TRP and a second TRP is provided. The UE includes at least one processor and at least one memory coupled to the at least one processor. The at least one memory stores one or more computer-executable instructions that, when executed by the at least one processor, cause the UE to apply a first Transmission Configuration Indication (TCI) state and a first Uplink (UL) power control configuration, which are associated with the first TRP, to perform a first UL transmission toward the first TRP; and apply a second TCI state and a second UL power control configuration, which are associated with the second TRP, to perform a second UL transmission toward the second TRP.

In some implementations of the second aspect of the present disclosure, the one or more computer-executable instructions, when executed by the at least one processor, further cause the UE to receive a Radio Resource Control (RRC) message from the first TRP, the RRC message including a set of UL power control configurations associated with the second TRP, the set of UL power control configurations including the second UL power control configuration; and receive a Medium Access Control (MAC) Control Element (CE) from one of the first TRP and the second TRP, the MAC CE indicating to the UE to apply the second UL power control configuration among the set of UL power control configurations to perform the second UL transmission.

In some implementations of the second aspect of the present disclosure, the one or more computer-executable instructions, when executed by the at least one processor, further cause the UE to indicate to a lower layer of a MAC layer of the UE information regarding the MAC CE.

In some implementations of the second aspect of the present disclosure, the MAC CE includes at least one of a serving cell Identity (ID) of a serving cell associated with the second TRP, a power control configuration ID of the second UL power control configuration, or a TCI state ID of the second TCI state.

In some implementations of the second aspect of the present disclosure, the MAC CE is received from the second TRP.

In some implementations of the second aspect of the present disclosure, the one or more computer-executable instructions, when executed by the at least one processor, further cause the UE to receive first unified TCI state type indication of a type of the first TCI state; and receive second unified TCI state type indication of a type of the second TCI state, wherein each of the type of the first TCI state and the type of the second TCI state is one of an UL TCI state and a joint TCI state.

In some implementations of the second aspect of the present disclosure, the one or more computer-executable instructions, when executed by the at least one processor, further cause the UE to determine a first UL transmission power for the first UL transmission according to the first UL power control configuration; determine a second UL transmission power for the second UL transmission according to the second UL power control configuration; use the first UL transmission power to transmit a first set of UL resources toward the first TRP; and use the second UL transmission power to transmit a second set of UL resources toward the second TRP.

In some implementations of the second aspect of the present disclosure, the first set of UL resources includes a first Physical Uplink Control Channel (PUCCH), a first Physical Uplink Shared Channel (PUSCH), and a first Sounding Reference Signal (SRS), and the second set of UL resources includes a second PUCCH, a second PUSCH, and a second SRS.

In some implementations of the second aspect of the present disclosure, the first TRP is associated with a source serving cell and the second TRP is associated with a target serving cell.

In some implementations of the second aspect of the present disclosure, the first TRP and the second TRP are associated with a same serving cell.

In some implementations of the second aspect of the present disclosure, the first UL power control configuration is associated with at least one of the first TCI state, a first TCI state Identity (ID) of the first TCI state, a first panel ID associated with the first TRP, a first cell ID associated with the first TRP, a first search space ID associated with the first TRP, a first Control Resource Set (CORESET) ID associated with the first TRP, a first CORESET pool index associated with the first TRP, or a first TRP-specific ID associated with the first TRP. The second UL power control configuration is associated with at least one of the second TCI state, a second TCI state ID of the second TCI state, a second panel ID associated with the second TRP, a second cell ID associated with the second TRP, a second search space ID associated with the second TRP, a second CORESET ID associated with the second TRP, a second CORESET pool index associated with the second TRP, or a second TRP-specific ID associated with the second TRP.

In some implementations of the second aspect of the present disclosure, the first UL power control configuration includes at least one of a first UL power control ID associated with the first TRP, a first P0 alpha set configuration for a first Physical Uplink Control Channel (PUCCH) associated with the first TRP, a second P0 alpha set configuration for a first Physical Uplink Shared Channel (PUSCH) associated with the first TRP, or a third P0 alpha set configuration for a first Sounding Reference Signal (SRS) associated with the first TRP. The second UL power control configuration includes at least one of a second UL power control ID associated with the second TRP, a fourth P0 alpha set configuration for a second PUCCH associated with the second TRP, a fifth P0 alpha set configuration for a second PUSCH associated with the second TRP, or a sixth P0 alpha set configuration for a second SRS associated with the second TRP.

In some implementations of the second aspect of the present disclosure, the first P0 alpha set configuration is the same as the fourth P0 alpha set configuration, the second P0 alpha set configuration is the same as the fifth P0 alpha set configuration, and the third P0 alpha set configuration is the same as the sixth P0 alpha set configuration.

According to a third aspect of the present disclosure, a Base Station (BS) for performing multi-Transmission and Reception Point (mTRP) operations to communicate with a User Equipment (UE) via a plurality of Transmission and Reception Points (TRPs) including a first TRP and a second TRP is provided. The BS includes at least one processor and at least one memory coupled to the at least one processor. The at least one memory stores one or more computer-executable instructions that, when executed by the at least one processor, cause the BS to configure the UE with a first Transmission Configuration Indication (TCI) state and a first Uplink (UL) power control configuration, which are associated with the first TRP, enabling the UE to perform a first UL transmission toward the first TRP based on the first TCI state and the first UL power control configuration; and configure the UE with a second TCI state and a second UL power control configuration, which are associated with the second TRP, enabling the UE to perform a second UL transmission toward the second TRP based on the second TCI state and the second UL power control configuration.

In some implementations of the third aspect of the present disclosure, the one or more computer-executable instructions, when executed by the at least one processor, further cause the BS to transmit, via the first TRP, a Radio Resource Control (RRC) message including a set of UL power control configurations associated with the second TRP to the UE, the set of UL power control configurations including the second UL power control configuration; and transmit, via one of the first TRP and the second TRP, a Medium Access Control (MAC) Control Element (CE) to the UE, the MAC CE indicating to the UE to apply the second UL power control configuration among the set of UL power control configurations to perform the second UL transmission.

In some implementations of the third aspect of the present disclosure, the MAC CE includes at least one of a serving cell Identity (ID) of a serving cell associated with the second TRP, a power control configuration ID of the second UL power control configuration, or a TCI state ID of the second TCI state.

In some implementations of the third aspect of the present disclosure, the one or more computer-executable instructions, when executed by the at least one processor, further cause the BS to transmit first unified TCI state type indication of a type of the first TCI state to the UE; and transmit second unified TCI state type indication of a type of the second TCI state to the UE, wherein each of the type of the first TCI state and the type of the second TCI state is one of an UL TCI state and a joint TCI state.

In some implementations of the third aspect of the present disclosure, the first TRP is associated with a source serving cell and the second TRP is associated with a target serving cell.

In some implementations of the third aspect of the present disclosure, the first TRP and the second TRP are associated with a same serving cell.

In some implementations of the third aspect of the present disclosure, the first UL power control configuration is associated with at least one of the first TCI state, a first TCI state Identity (ID) of the first TCI state, a first panel ID associated with the first TRP, a first cell ID associated with the first TRP, a first search space ID associated with the first TRP, a first Control Resource Set (CORESET) ID associated with the first TRP, a first CORESET pool index associated with the first TRP, or a first TRP-specific ID associated with the first TRP. The second UL power control configuration is associated with at least one of the second TCI state, a second TCI state ID of the second TCI state, a second panel ID associated with the second TRP, a second cell ID associated with the second TRP, a second search space ID associated with the second TRP, a second CORESET ID associated with the second TRP, a second CORESET pool index associated with the second TRP, or a second TRP-specific ID associated with the second TRP.

In some implementations of the third aspect of the present disclosure, the first UL power control configuration includes at least one of a first UL power control ID associated with the first TRP, a first P0 alpha set configuration for a first Physical Uplink Control Channel (PUCCH) associated with the first TRP, a second PO alpha set configuration for a first Physical Uplink Shared Channel (PUSCH) associated with the first TRP, or a third P0 alpha set configuration for a first Sounding Reference Signal (SRS) associated with the first TRP. The second UL power control configuration includes at least one of a second UL power control ID associated with the second TRP, a fourth P0 alpha set configuration for a second PUCCH associated with the second TRP, a fifth P0 alpha set configuration for a second PUSCH associated with the second TRP, or a sixth P0 alpha set configuration for a second SRS associated with the second TRP.

In some implementations of the third aspect of the present disclosure, the first P0 alpha set configuration is the same as the fourth P0 alpha set configuration, the second P0 alpha set configuration is the same as the fifth P0 alpha set configuration, and the third P0 alpha set configuration is the same as the sixth P0 alpha set configuration.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a flowchart of a method for mTRP operations, according to an example implementation of the present disclosure.

FIG. 2 is a flowchart of a method for mTRP operations, according to an example implementation of the present disclosure.

FIG. 3 is a flowchart of a method for mTRP operations, according to an example implementation of the present disclosure.

FIG. 4 is a flowchart of a method for mTRP operations, according to an exemplary implementation of the present disclosure.

FIG. 5 is a schematic diagram illustrating an intra-node scenario, according to an example implementation of the present disclosure.

FIG. 6 is a schematic diagram illustrating an intra-Central Unit (CU) inter-Distributed Unit (DU) case, according to an example implementation of the present disclosure.

FIG. 7 is a schematic diagram illustrating an inter-node scenario, according to an example implementation of the present disclosure.

FIG. 8 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrases “In some implementations,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C,” “at least one of the following: A, B and C,” “at least one of A, B or C,” and “at least one of the following: A, B or C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules which may be software, hardware, firmware, or any combination thereof. The software implementation may comprise computer executable instructions stored on computer readable medium such as memory or other type of storage devices. For example, one or more microprocessors or general-purpose computers with communication processing capability may be programmed with corresponding executable instructions and carry out the described network function(s) or algorithm(s). The microprocessors or general-purpose computers may be formed of Applications Specific Integrated Circuitry (ASIC), programmable logic arrays, and/or using one or more Digital Signal Processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long Term Evolution (LTE) system, an LTE-Advanced (LTE-A) system, an LTE-Advanced Pro system, or a 5G New Radio (NR) Radio Access Network (RAN)) typically includes at least one Base Station (BS), at least one User Equipment (UE), and one or more optional network elements that provide connection toward a network. The UE communicates with the network (e.g., a Core Network (CN), an Evolved Packet Core (EPC) network, an Evolved Universal Terrestrial Radio Access Network (E-UTRAN), a 5G Core (5GC), or an internet), through a RAN established by one or more BSs.

It should be noted that, in the present application, a UE may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using a plurality of cells forming the radio access network. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink (DL) and optionally uplink (UL) resources to at least one UE within its radio coverage for DL and optionally UL packet transmissions). The BS can communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a DL transmission data, a guard period, and an UL transmission data should at least be included, where the respective portions of the DL transmission data, the guard period, the UL transmission data should also be configurable, for example, based on the network dynamics of NR. In addition, SL resources may also be provided in an NR frame to support ProSe services or V2X services.

In addition, the terms “system” and “network” herein may be used interchangeably. The term “and/or” herein is only an association relationship for describing associated objects, and represents that three relationships may exist. For example, A and/or B may indicate that: A exists alone, A and B exist at the same time, or B exists alone. In addition, the character “/” herein generally represents that the former and latter associated objects are in an “or” relationship. Multiple PLMNs may operate on the unlicensed spectrum. Multiple PLMNs may share the same unlicensed carrier. The PLMNs may be public or private. Public PLMNs may be (but not limited to) the operators or virtual operators, which provides radio services to the public subscribers. Public PLMNs may own the licensed spectrum and support the radio access technology on the licensed spectrum as well. Private PLMNs may be (but not limited to) the micro-operators, factories, or enterprises, which provides radio services to its private users (e.g., employees or machines). In some implementations, public PLMNs may support more deployment scenarios (e.g., carrier aggregation between licensed band NR (PCell) and NR-U (SCell), dual connectivity between licensed band LTE (PCell) and NR-U (PSCell), stand-alone NR-U, an NR cell with DL in unlicensed band and UL in licensed band, dual connectivity between licensed band NR (PCell) and NR-U (PSCell)). In some implementations, private PLMNs mainly support (but not limited to) the stand-alone unlicensed radio access technology (e.g., stand-alone NR-U).

The terms, definitions, and abbreviations as given in this document are either imported from existing documentation (European Telecommunications Standards Institute (ETSI), International Telecommunication Union (ITU), or elsewhere) or newly created by 3GPP experts whenever the need for precise vocabulary is identified.

Multi-Input Multi-Output (MIMO) is one of the key technologies in 5G systems to achieve the high data rate and fulfill the requirement of enhanced Mobile Broad Band (eMBB). Moreover, MIMO technique is successful in commercial deployment. MIMO features are investigated and specified for both Frequency Division Duplex (FDD) and Time Division Duplex (TDD) systems, of which major parts were for DL MIMO operation. In addition, it is important to enhance the UL MIMO, while necessary enhancements on DL MIMO that facilitate the use of large antenna array, not only for Frequency Range 1 (FR1) but also for Frequency Range 2 (FR2), would still need to be introduced to fulfil the request for evolution of NR deployments.

Multi Transmission and Reception Point (which is also referred to as Multi-TRP, mTRP, or multiple-TRP) is introduced to enhance the massive MIMO. Moreover, mTRP feature can improve the reliability, coverage, and capacity performance through flexible deployment scenarios. In mTRP operations, the BS can communicate with the UE through multiple TRPs. Each TRP may be associated with a specific Sounding Reference Signal (SRS) resource set, spatial relation information, one or more specific Radio Resource Control (RRC) parameters (e.g., CORESETPoolIndex, TRP ID, panel ID), and/or a specific Transmission Configuration Indication (TCI) state (e.g., a DL TCI state, a joint TCI state, or an UL TCI state). A TCI state may include parameters for configuring a Quasi Co-Location (QCL) relationship between one or two DL Reference Signals (RSs) and a target RS set. For example, a target RS set may be the Demodulation Reference Signal (DMRS) ports of Physical Downlink Shared Channel (PDSCH) or the DMRS ports of Physical Downlink Control Channel (PDCCH).

In multi-beam operations, especially targeting at FR2, a unified TCI framework may be introduced to facilitate the streamlined multi-beam operation and reduce the signaling overhead. The unified TCI framework can be applied not only to single-TRP cases but also to multi-TRP cases. The mTRP operations for UL may include, but is not limited to, a UE performing simultaneous multi-panel UL transmissions. There are three types of TCI states (e.g., DL TCI state, UL TCI state and joint TCI state) defined in the unified TCI framework. The DL TCI state may include parameters for configuring a QCL relationship between one or two DL RSs and a target RS set. For example, a target RS set may be the DMRS ports of PDSCH or the DMRS ports of PDCCH. The UL TCI state may include parameters for providing a reference RS (e.g., Synchronization Signal Block (SSB) index, Channel State Information-Reference Signal (CSI-RS) index and/or SRS) for determining UL transmission (TX) spatial filter for dynamic-grant and configured-grant based Physical Uplink Shared Channel (PUSCH) and Physical Uplink Control Channel (PUCCH) resource in a Component Carrier (CC), and SRS. The joint TCI state may not only include parameters for configuring a QCL relationship between one or two DL RSs and a target RS but also include parameters for providing a RS (e.g., SSB index, CSI-RS index and/or SRS) for determining UL TX spatial filter for dynamic-grant and configured-grant based PUSCH and PUCCH resource in a CC, and SRS.

With the advancement of MIMO techniques, there is growing interest in inter-cell mobility and intra-cell mobility, which may include aspects such as inter-cell beam management and intra-cell beam management. It might be beneficial to explore inter-cell/intra-cell mobility, particularly in mTRP operation, as this could potentially lead to reductions in latency and signaling overhead, and possibly facilitate higher data rate.

Furthermore, when the UE is performing inter-cell beam management or inter-cell mobility, it is fundamental but important for the UE to perform the UL transmission (e.g., PUCCH transmission, PUSCH transmission, SRS transmission), to the serving cell (e.g., source serving cell) and/or to the inter-cell of the serving cell (e.g., target serving cell). However, utilizing the UL power control based on the unified TCI framework when the UE is configured with inter-cell beam management and/or when the UE is configured to perform inter-cell mobility and/or when the UE is in mTRP operation presents certain complexities. In the present disclosure, a mechanism for configuring UL power control is introduced, which employs the unified TCI framework. This mechanism can be advantageous in various scenarios, such as when the UE is engaged in inter-cell/intra-cell beam management, inter-cell/intra-cell mobility, or mTRP operations, among others. The mechanism has the potential to achieve signaling overhead reduction and energy efficiency, for example, by applying the UL power control in the unified TCI framework. Moreover, it may serve as a foundational aspect of inter-cell and/or intra-cell beam management and mobility.

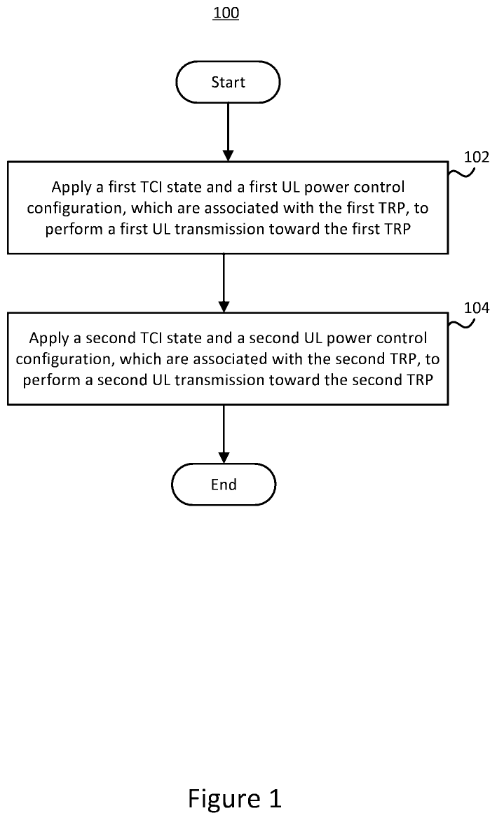

FIG. 1 is a flowchart of a method 100 for mTRP operations, according to an example implementation of the present disclosure. In the mTRP operations, a UE may communicate with multiple TRPs including, at least, a first TRP and a second TRP through different beams toward each TRP. For example, when mTRP operations are applied/performed, a serving cell (or BS) may schedule a UE from at least two TRPs. The mTRP operations are proposed and designed to provide more extensive coverage, enhance the reliability, and improve the data rate for DL channels (e.g., PDSCH, PDCCH), DL RS (e.g., CSI-RS), UL channels (e.g., PUSCH, PUCCH) and UL RS (e.g., SRS) transmission/reception.

In action 102, the UE may apply (e.g., select and/or use) a first TCI state and a first UL power control configuration, which are associated with the first TRP, to perform a first UL transmission toward the first TRP.

In action 104, the UE may apply a second TCI state and a second UL power control configuration, which are associated with the second TRP, to perform a second UL transmission toward the second TRP.

It is noted that although actions 102 and 104 are illustrated as separate actions represented as independent blocks in FIG. 1, these separately illustrated actions should not be construed as necessarily order-dependent. The order in which the actions are performed in FIG. 1 is not intended to be construed as a limitation, and any number of the disclosed blocks can be combined in any order to implement the method, or an alternate method. For example, actions 102 and 104 can be performed by the UE concurrently or simultaneously. Moreover, each of actions 102 and 104 may be performed independently of other actions and can be omitted in some implementations of the present disclosure.

According to the method 100, the UE may employ a TRP-specific (or per-TRP) UL power control by applying respective TCI states and power control configurations for each TRP. By using respective TCI states and UL power control configurations for each TRP, the UE may effectively manage UL transmissions toward each TRP, thereby forming the foundation for reliable and adaptive communications in scenarios involving the mTRP operations.

In some implementations, the first UL power control configuration may be associated with at least one of the following: the first TCI state, a first TCI state ID of the first TCI state, a first panel ID associated with the first TRP, a first cell ID associated with the first TRP, a first search space ID associated with the first TRP, a first CORESET ID associated with the first TRP, a first CORESET pool index associated with the first TRP, or a first TRP-specific ID associated with the first TRP. The second UL power control configuration may be associated with at least one of the following: the second TCI state, a second TCI state ID of the second TCI state, a second panel ID associated with the second TRP, a second cell ID associated with the second TRP, a second search space ID associated with the second TRP, a second CORESET ID associated with the second TRP, a second CORESET pool index associated with the second TRP, or a second TRP-specific ID associated with the second TRP.

In order to establish the associations between different parameters, configurations, TRPs, and/or cells described in the present disclosure, a variety of mechanisms can be utilized. For example, the UE may receive one or more Information Elements (IEs) from a network node (e.g., a BS). The IE(s) may be used to define the associations explicitly or implicitly by including and/or indicating the relevant parameters, configurations, TRPs, and/or cells. Additionally, the associations may also be established through a shared identifier or index that is common among at least part of the parameters, configurations, TRPs, and/or cells.

The mTRP operations may be used for inter-cell cases (e.g., inter-cell mobility, inter-cell beam management) or single-cell (or intra-cell) (e.g., intra-cell mobility, intra-cell beam management) cases. For example, in the inter-cell cases, the first TRP may be associated with a source serving cell and the second TRP may be associated with a target serving cell. In the single-cell cases, the first TRP and the second TRP may be associated with the same serving cell.

Different power control configurations may include one or more TRP-specific parameters and/or one or more TCI-state-specific parameters. For example, the first UL power control configuration may include at least one of the following: a first UL power control ID associated with the first TRP, a first P0 alpha set configuration for a first PUCCH associated with the first TRP, a second P0 alpha set configuration for a first PUSCH associated with the first TRP, or a third P0 alpha set configuration for a first SRS associated with the first TRP. The second UL power control configuration may include at least one of the following: a second UL power control ID associated with the second TRP, a fourth P0 alpha set configuration for a second PUCCH associated with the second TRP, a fifth P0 alpha set configuration for a second PUSCH associated with the second TRP, or a sixth P0 alpha set configuration for a second SRS associated with the second TRP. In some implementations, two or more power control configurations may share the same P0 alpha set configuration. For example, the first P0 alpha set configuration may be the same as the fourth P0 alpha set configuration, the second P0 alpha set configuration may be the same as the fifth P0 alpha set configuration, and/or the third P0 alpha set configuration may be the same as the sixth P0 alpha set configuration.

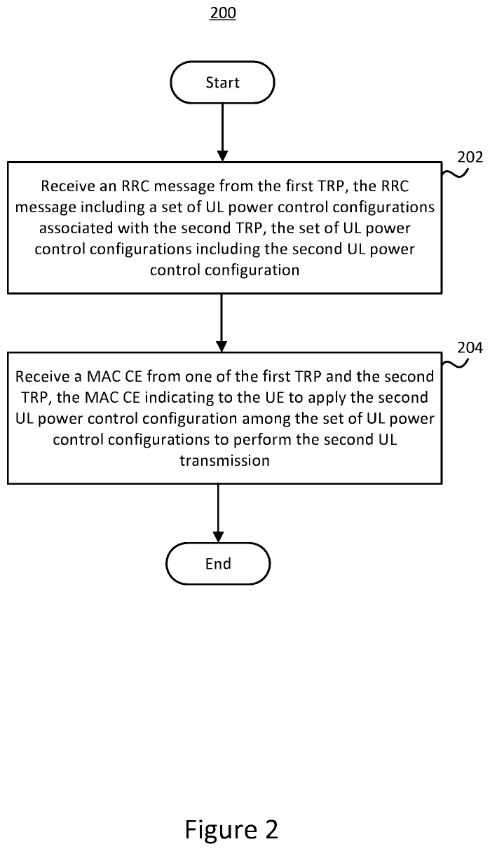

FIG. 2 is a flowchart of a method 200 for mTRP operations, according to an example implementation of the present disclosure. The method 200 can be considered as either a further elaboration of the method 100 illustrated in FIG. 1, providing more detailed actions, or as an independent approach providing a more detailed or alternative way to handle the mTRP operations. The method 200 may be designed to be seamlessly integrated with the method 100 and/or other methods/mechanisms described in the present disclosure, thereby constructing a comprehensive solution catering to various mTRP operation scenarios. Additionally, the terminology used in method 200, such as “first TRP”, “second UL power control configuration”, “second TRP” and “second UL transmission”, is consistent with or corresponds to the terminology used in the method 100.

In action 202, the UE may receive an RRC message from the first TRP. The RRC message may include a set of UL power control configurations associated with the second TRP. The set of UL power control configurations may include the second UL power control configuration (associated with the second TRP).

In action 204, the UE may receive a MAC CE from one of the first TRP and the second TRP. The MAC CE may indicate to the UE to apply the second UL power control configuration among the set of UL power control configurations to perform the second UL transmission.

According to the method 200, the UE may receive from the first TRP a set of UL power control configurations associated with another TRP, referred to as the second TRP. The UE may then receive indication, e.g., in the form of a MAC CE, on which UL power control configuration among the set of UL power control configurations to use for the second TRP. The indication may come from the first TRP or the second TRP, providing flexibility. In some implementations, the MAC CE may be received by the UE from the second TRP. The serving cell associated with the second TRP may contain information specific to communication with the second TRP, thereby facilitating more efficient communication, e.g., enhancements on throughput, data rate and/or reliability.

The UE may indicate to a lower layer of a MAC layer of the UE information regarding the MAC CE. The MAC CE may include information that is directly or indirectly related to the UL power control configuration to be used (e.g., the second UL power control configuration) and/or the second TRP. For example, the MAC CE may include at least one of a serving cell ID of a serving cell associated with the second TRP, a power control configuration ID of the second UL power control configuration, or a TCI state ID of the second TCI state.

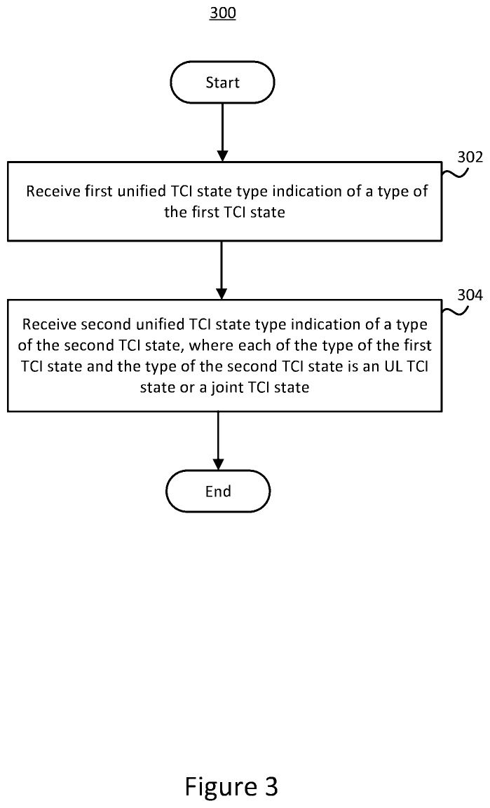

FIG. 3 is a flowchart of a method 300 for mTRP operations, according to an example implementation of the present disclosure. The method 300 can be seen as either a continuation of the earlier mentioned methods, including the method 100 and/or the method 200, with additional detailed actions for mTRP operations, or as a standalone approach offering a different or more detailed way to handle mTRP operations. Moreover, the method 300 can be integrated with the method 100, the method 200, and/or other methods described in the present disclosure. Additionally, the method 300 uses terminology that is consistent with or corresponds to the terminology utilized in the method 100 and the method 200.

In action 302, the UE may receive first unified TCI state type indication of a type of the first TCI state.

In action 304, the UE may receive second unified TCI state type indication of a type of the second TCI state. Each of the type of the first TCI state and the type of the second TCI state may be a unified TCI state type under the unified TCI framework, e.g., an UL TCI state or a joint TCI state.

It is noted that although actions 302 and 304 are illustrated as separate actions represented as independent blocks in FIG. 3, these separately illustrated actions should not be construed as necessarily order-dependent. The order in which the actions are performed in FIG. 3 is not intended to be construed as a limitation, and any number of the disclosed blocks can be combined in any order to implement the method, or an alternate method. For example, actions 302 and 304 can be performed by the UE concurrently or simultaneously. Moreover, each of actions 302 and 304 may be performed independently of other actions and can be omitted in some implementations of the present disclosure.

According to method 300, the UE may perform UL transmissions toward each TRP based on the unified TCI framework. Within this unified TCI framework, two modes are available: separate mode and joint mode. Depending on the mode to be configured, the type of the TCI state used for an UL transmission to a particular TRP can be set either as an UL TCI state (corresponding to the separate mode) or as a joint TCI state (corresponding to the joint mode). For each TRP, the UE may receive respective unified TCI state type indication (e.g., the first unified TCI state type indication and the second unified TCI state type indication), which indicates the type of the TCI state associated with that TRP. This enables the UE to optimize its communication with each TRP according to the settings defined under the unified TCI framework. In some implementations, the type(s) of the TCI states for two or more TRPs may be indicated through the same unified TCI state type indication.

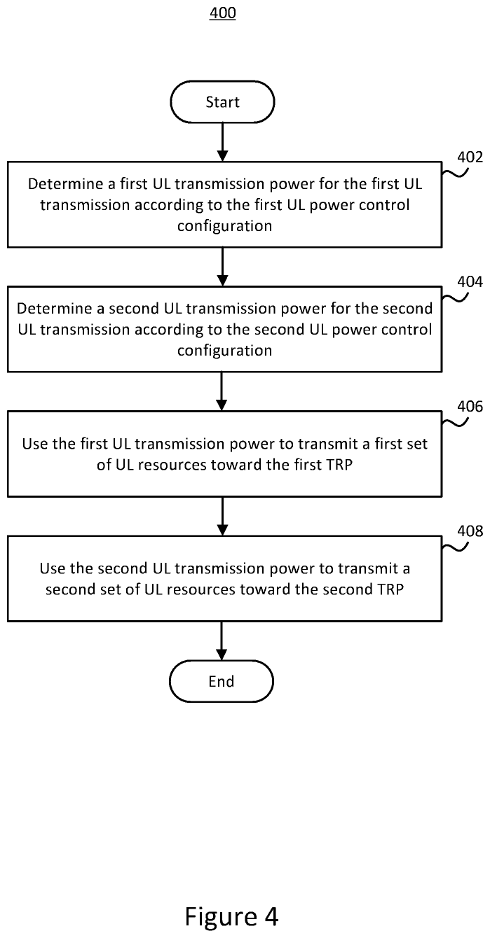

FIG. 4 is a flowchart of a method 400 for mTRP operations, according to an exemplary implementation of the present disclosure. The method 400 may serve as an extension of any of the previously mentioned methods, including the method 100, the method 200, and/or the method 300, by contributing additional actions for mTRP operations. Alternatively, the method 400 can be regarded as a standalone approach offering a different or more detailed way to handle mTRP operations. Moreover, the method 400 can be integrated with the method 100, the method 200, the method 300 and/or other methods described in the present disclosure. Additionally, the method 400 uses terminology that is consistent with or corresponds to the terminology utilized in the method 100, the method 200, and the method 300.

In action 402, the UE may determine a first UL transmission power for the first UL transmission (e.g., toward the first TRP) according to the first UL power control configuration.

In action 404, the UE may determine a second UL transmission power for the second UL transmission according to the second UL power control configuration.

In action 406, the UE may use (or apply) the first UL transmission power to transmit a first set of UL resources toward the first TRP.

In action 408, the UE may use (or apply) the second UL transmission power to transmit a second set of UL resources toward the second TRP.

It is noted that although actions 402, 404, 406, and 408 are illustrated as separate actions represented as independent blocks in FIG. 4, these separately illustrated actions should not be construed as necessarily order-dependent. The order in which the actions are performed in FIG. 4 is not intended to be construed as a limitation, and any number of the disclosed blocks can be combined in any order to implement the method, or an alternate method. For example, actions 402 and 404 can be performed by the UE concurrently or simultaneously; actions 406 and 408 can be performed by the UE concurrently or simultaneously. Moreover, each of actions 402, 404, 406, and 408 may be performed independently of other actions and can be omitted in some implementations of the present disclosure.

According to the method 400, the UE may perform individualized UL power control/management for UL transmissions toward each TRP. The UE may determine the UL transmission powers for each TRP (e.g., the first UL transmission power for the first TRP and the second UL transmission power for the second TRP). The determinations may be based on the corresponding power control configurations. The UE may then apply the determined UL transmission power to transmit a set of UL resources to a respective TRP.

In some implementations, the first set of UL resources may include a first PUCCH, a first PUSCH, and a first SRS. The second set of UL resources may include a second PUCCH, a second PUSCH, and a second SRS. In such implementations, the first PUCCH, the first PUSCH, and the first SRS are transmitted to the first TRP based on the same UL transmission power (e.g., the first UL transmission power); the second PUCCH, the second PUSCH, and the second SRS are transmitted to the second TRP based on the same UL transmission power (e.g., the second UL transmission power).

It should be noted that in the present disclosure, the BS may perform methods/actions corresponding to those performed by the UE. For example, the receiving actions performed by the UE may correspond to the transmitting/configuring actions of the BS; the transmitting actions performed by the UE may correspond to the receiving actions of the BS. That is, the BS and the UE can have reciprocally aligned roles in transmission and reception. Consequently, the methods or actions executed by the BS can be combined or integrated in a similar manner to how the methods or actions are executed by the UE.

For example, when viewed from the BS's perspective, the method 100 may correspond to a method performed by the BS. The BS may perform mTRP operations to communicate with the UE via a plurality of TRPs including a first TRP and a second TRP. The BS may configure the UE (e.g., through RRC signaling) with a first TCI state and a first UL power control configuration, which are associated with the first TRP, enabling the UE to perform a first UL transmission toward the first TRP based on the first TCI state and the first UL power control configuration. The BS may also configure the UE (e.g., through RRC signaling) with a second TCI state and a second UL power control configuration, which are associated with the second TRP, enabling the UE to perform a second UL transmission toward the second TRP based on the second TCI state and the second UL power control configuration.

The method 200 may also correspond to a method performed by the BS. For example, the BS may transmit, via the first TRP, an RRC message including a set of UL power control configurations associated with the second TRP to the UE. The set of UL power control configurations may include the second UL power control configuration. The BS may transmit, via one of the first TRP and the second TRP, a MAC CE to the UE, where the MAC CE indicates to the UE to apply the second UL power control configuration among the set of UL power control configurations to perform the second UL transmission. The MAC CE may include at least one of the following: a serving cell ID of a serving cell associated with the second TRP, a power control configuration ID of the second UL power control configuration, or a TCI state ID of the second TCI state.

The method 300 may also correspond to a method performed by the BS. For example, the BS may transmit first unified TCI state type indication of a type of the first TCI state to the UE and transmit second unified TCI state type indication of a type of the second TCI state to the UE, where each of the type of the first TCI state and the type of the second TCI state is one of an UL TCI state and a joint TCI state.

The following content provides further elaboration on various aspects of the present disclosure and details of the methods/mechanisms/approaches executed by the UE or the BS (e.g., including the methods 100, 200, 300, and 400).

As described earlier, when mTRP operations are applied/performed, a serving cell (or BS) may schedule a UE from at least two TRPs. The mTRP operations are proposed and designed to provide more extensive coverage, enhance the reliability, and improve the data rate for DL channels, DL RS, UL channels and UL RS transmission/reception.

If the mTRP PUCCH repetitions are applied, the UE may perform PUCCH transmission of the same Uplink Control Information (UCI) contents (or Transport Block (TB)) toward two TRPs (e.g., the first TRP and the second TRP described with reference to FIG. 1, 2, 3, and/or 4) with corresponding beam directions associated with different spatial relation information, different UL TCI states and/or different joint TCI states. The spatial relation information, UL TCI states or joint TCI states may include parameters for configuring a spatial relation between RSs (e.g., SRS, CSI-RS, and/or SSB) and a target RS set. For example, a target RS set may be the DM-RS ports of PUSCH or PUCCH. The spatial relation information, UL TCI states and joint TCI states may further include parameters for configuring power control for PUCCH or PUSCH, respectively. The spatial relation information, UL TCI states and joint TCI states may be indicated by a MAC CE or Downlink Control Information (DCI). For example, the UE may receive a MAC CE or DCI from the network, a serving cell, a target cell or a non-serving cell. The MAC CE or the DCI may indicate the spatial relation information, UL TCI states and/or joint TCI states. The term ‘joint TCI state’ may be equivalent to, or similar with, ‘DLorJoint TCI state’ in the present disclosure.

In the single-cell (intra-cell) case, the two TRPs may be associated with a Physical Cell Identity (PCI) of the serving cell.

In the inter-cell case, the two TRPs may be associated with different PCIs. For example, one TRP may be associated with the PCI of the serving cell, while another TRP may be associated with a PCI different from the PCI of the serving cell.

If mTRP PUSCH repetition is applied, according to the indications in single DCI received by the UE from the serving cell (or from the TRP associated with the serving cell) and/or the indications in a semi-static configured grant provided over an RRC message received by the UE from the serving cell (or from the TRP associated with the serving cell), the UE may perform a set of PUSCH transmissions with the same UCI contents (or transport blocks) toward the two TRPs with corresponding beam directions associated with different spatial relation information, different SRS resource sets, different UL TCI states and/or different joint TCI states in the time domain. Furthermore, the spatial relation information, SRS resource sets, UL TCI states and/or joint TCI states may be further indicated by a MAC CE or DCI (e.g., SRS resource indicator). For example, the UE may receive a MAC CE or DCI from the network, a serving cell, a target cell or a non-serving cell, where the MAC CE or the DCI indicates the spatial relation information, SRS resource sets, UL TCI states and/or joint TCI states.

In the single-cell (intra-cell) case, the two TRPs may be associated with a PCI of the serving cell. In the inter-cell case, the two TRPs may be associated with different PCIs. For example, one TRP may be associated with the PCI of the serving cell, while another TRP may be associated with a PCI different from the PCI of the serving cell. The PCI different from the PCI of the serving cell may be used to identify a cell other than the serving cell.

For the inter-cell case, the UE may receive the indications in single DCI from the serving cell (or from the TRP associated with the serving cell) or from the TRP associated with a PCI different from the PCI of the serving cell. For the inter-cell case, the UE may receive the indications in a semi-static configured grant over an RRC message from the serving cell (or from the TRP associated with the serving cell) or from the TRP associated with a PCI different from the PCI of the serving cell.

The UE may be configured with inter-cell beam management by the NW, by pre-configuration, or by UE capability. For example, after receiving the configuration including information related to inter-cell beam management, the UE may determine that it is configured with inter-cell beam management by the NW. The configuration including information related to inter-cell beam management may be included in an RRC message, a MAC CE and/or DCI.

The configuration including information related to inter-cell beam management may be or may include (but not limited to) the information of TCI configuration associated with a TRP associated with a PCI different from the PCI of the serving cell, the information of spatial relations configuration associated with a TRP associated with a PCI different from the PCI of the serving cell, the information of RS configuration associated with the TCI configuration associated with a TRP associated with a PCI different from the PCI of the serving cell, the information of RS configuration associated with the spatial relations configuration associated with a TRP associated with a PCI different from the PCI of the serving cell, the information of TCI configuration associated with a TRP associated with the PCI of the serving cell, the information of spatial relations configuration associated with a TRP associated with the PCI of the serving cell, the information of RS configuration associated with the TCI configuration associated with a TRP associated with the PCI of the serving cell, and/or the information of RS configuration associated with the spatial relations configuration associated with a TRP associated with the PCI of the serving cell. Note that the TCI configuration may be DL TCI configuration (e.g., a list of TCI states configured for DL channels), UL TCI configuration (e.g., a list of TCI states configured for UL channels), and/or joint TCI configuration (e.g., a list of TCI states configured for both DL channels and UL channels). Similarly, the information of RS configurated with the TCI configuration may be the information of RS configured with the DL TCI configuration, UL TCI configuration, and/or joint TCI configuration. Furthermore, the above-mentioned TCI configuration may be associated with PDSCH configuration, PUSCH configuration, PDCCH configuration, PUCCH configuration, PRACH configuration, a BWP dedicated configuration, SRS configuration and/or a serving cell configuration.

For example, the UE may be preconfigured with the capability to perform inter-cell beam management. The pre-configuration may be stored in UMTS Subscriber Identity Module (USIM), based on the UE itself and/or based on the releases. The UE may be preconfigured with inter-cell beam management. The UE may determine whether it is configured with inter-cell beam management based on the preconfigured information.

For example, after the UE receives UE Capability Enquiry message from the serving cell, the UE may include the information related to the capability of performing the inter-cell beam management in UE Capability Information message. Afterward, the UE (e.g., especially the RRC layer of the UE) may submit UE Capability Information message to lower layers (e.g., PDCP layer of the UE, MAC layer of the UE, PHY layer of the UE) for transmission to the serving cell.

After the reception of UE Capability Enquiry message, the UE may determine whether at least one of the information regarding the support of inter-cell beam management, the information regarding the support of enhanced MIMO (feMIMO), the information regarding the support of a higher frequency band (e.g., FR2), and the information regarding the support of NR, exists in UE Capability Enquiry message.

If at least one of the information regarding the support of inter-cell beam management, the information regarding the support of feMIMO, the information regarding the support of a higher frequency band (e.g., FR2), and the information regarding the support of NR exists in UE Capability Enquiry message, the UE may further determine whether it supports inter-cell beam management and/or whether it is (pre) configured with inter-cell beam management.

If none of the information regarding the support of inter-cell beam management, the information regarding the support of feMIMO, the information regarding the support of a higher frequency band (e.g., FR2), and the information regarding the support of NR exists in UE Capability Enquiry message, the UE may not further determine whether it supports inter-cell beam management nor whether it is (pre) configured with inter-cell beam management.

After the UE determines that it supports inter-cell beam management and/or it is (pre) configured with inter-cell beam management, the UE may include the information related to the capability of performing the inter-cell beam management in UE Capability Information message.

After the UE determines that it does not support inter-cell beam management nor it is not (pre) configured with inter-cell beam management, the UE may not include the information related to the capability of performing the inter-cell beam management in UE Capability Information message.

In one example, the UE Capability Information message may include the supported number of cells for operating Inter-Cell Beam Management (ICBM).

For inter-cell beam management (e.g., if the UE is configured with inter-cell beam management), the UE may receive or transmit UE-dedicated channels/signals via a TRP associated with a PCI different from the PCI of the serving cell and/or a TRP associated with the PCI of the serving cell, while non-UE-dedicated channel/signals can only be received via a TRP associated with the PCI of the serving cell. The methods/mechanisms/approaches (e.g., including the methods 100, 200, 300, and 400) in the present disclosure may be applied to the inter-cell beam management cases and/or the intra-cell beam management cases. For example, in the case of inter-cell beam management, the first TRP may be associated with a first PCI of a first serving cell, and the second TRP may be associated with a second PCI of a second serving cell. In the case of intra-cell beam management, the first TRP and the second TRP may be associated with the same PCI (or the same serving cell).

The UE dedicated channels/signals may include, but not limited to, the messages/signals/information via logical channels such as Dedicated Control Channel (DCCH) and Dedicated Traffic Channel (DTCH). In some implementations, the UE dedicated channels/signals may include, but not limited to, the signals/information via PDCCH and PUCCH.

In the following, explanations are provided for multiple types of UE dedicated channels.

DCCH: DCCH is a point-to-point bi-directional (including UL and DL) control channel that transmits dedicated control (plane) information between a UE and the network. DCCH may be used by a UE having an RRC connection.

DCCH—DL-SCH (The logical channel DCCH can be mapped to the transport channel DL-SCH): The MAC entity of the UE may receive the DL control message/information/signals on the transport channel DL-SCH. After the processing in the MAC entity of the UE, the MAC entity of the UE may transfer the processed DL control message/information/signals via the logical channel DCCH to the upper layer (e.g., the PDCP layer of the UE, the RRC layer of the UE). For example, the RRC layer of the UE may receive the DL RRC message such as RRC Reconfiguration message, RRC Resume message, RRC Reestablishment message, RRC Release message, UE Capability Enquiry message, UE Information Request message, and Logged Measurement Configuration message, via the logical channel DCCH mapped to the transport channel DL-SCH, from the lower layers of the UE.

DCCH—UL-SCH (The logical channel DCCH can be mapped to the transport channel UL-SCH): The MAC entity of the UE may receive the UL control message/information/signals on the logical channel DCCH. After the processing in the MAC entity of the UE, the MAC entity of the UE may transfer the processed UL control message/information/signals via the transport channel UL-SCH to the lower layer (e.g., the PHY layer of the UE). For example, the RRC layer of the UE may transmit the UL RRC message such as RRC Reconfiguration Complete message, RRC Resume Complete message, RRC Reestablishment Complete message, RRC Setup Complete message, Measurement Report message, UE Capability Information message, UE Assistance Information message, and Dedicated SIB Request message, via the logical channel DCCH mapped to the transport channel UL-SCH, to the lower layers of the UE.

DTCH: DTCH is a point-to-point traffic channel, dedicated to one UE, for the transfer of user (plane) information. A DTCH can exist in both UL and DL.

DTCH—DL-SCH (The logical channel DTCH can be mapped to the transport channel DL-SCH): The MAC entity of the UE may receive the DL user information/signals on the transport channel DL-SCH. After the processing in the MAC entity of the UE, the MAC entity of the UE may transfer the processed DL user information/signals via the logical channel DTCH to the upper layer (e.g., the PDCP layer of the UE, the RRC layer of the UE).

DTCH—UL-SCH (The logical channel DTCH can be mapped to the transport channel UL-SCH): The MAC entity of the UE may receive the UL user information/signals on the logical channel DTCH. After the processing in the MAC entity of the UE, the MAC entity of the UE may transfer the processed UL user information/signals via the transport channel UL-SCH to the lower layer (e.g., the PHY layer of the UE).

The non-UE-dedicated channels/signals may include, but not limited to, the messages/signals/information via logical channels such as Broadcast Control Channel (BCCH), Paging Control Channel (PCCH) and Common Control Channel (CCCH).

In the following, explanations are provided for multiple types of non-UE-dedicated channels.

BCCH: BCCH is a DL channel for broadcasting system control information.

BCCH—BCH (The logical channel BCCH can be mapped to the transport channel BCH): The MAC entity of the UE may receive the DL control message/information/signals on the transport channel BCH. After the processing in the MAC entity of the UE, the MAC entity of the UE may transfer the processed DL control message/information/signals via the logical channel BCCH to the upper layer (e.g., the PDCP layer of the UE, the RRC layer of the UE). For example, the RRC layer of the UE may receive the MIB message, via the logical channel BCCH mapped to the transport channel BCH, from the lower layers of the UE.

BCCH—DL-SCH (The logical channel BCCH can be mapped to the transport channel DL-SCH): The MAC entity of the UE may receive the DL control message/information/signals on the transport channel DL-SCH. After the processing in the MAC entity of the UE, the MAC entity of the UE may transfer the processed DL control message/information/signals via the logical channel BCCH to the upper layer (e.g., the PDCP layer of the UE, the RRC layer of the UE). For example, the RRC layer of the UE may receive the SIB1 message and System Information message, via the logical channel BCCH mapped to the transport channel DL-SCH, from the lower layers of the UE.

PCCH: PCCH is a DL channel that carries paging messages.

PCCH—PCH (The logical channel PCCH can be mapped to the transport channel PCH): The MAC entity of the UE may receive the DL control message/information/signals on the transport channel PCH. After the processing in the MAC entity of the UE, the MAC entity of the UE may transfer the processed DL control message/information/signals via the logical channel PCCH to the upper layer (e.g., the PDCP layer of the UE, the RRC layer of the UE). For example, the RRC layer of the UE may receive the Paging message, via the logical channel PCCH mapped to the transport channel PCH, from the lower layers of the UE.

CCCH: CCCH is a channel for transmitting control information between UEs and the network. This channel is used for UEs having no RRC connection with the network.

CCCH—DL-SCH (The logical channel CCCH can be mapped to the transport channel DL-SCH): The MAC entity of the UE may receive the DL control message/information/signals on the transport channel DL-SCH. After the processing in the MAC entity of the UE, the MAC entity of the UE may transfer the processed DL control message/information/signals via the logical channel CCCH to the upper layer (e.g., the PDCP layer of the UE, the RRC layer of the UE). For example, the RRC layer of the UE may receive the DL RRC message such as RRC Setup message and RRC Reject message, via the logical channel CCCH mapped to the transport channel DL-SCH, from the lower layers of the UE.

CCCH—UL-SCH (The logical channel CCCH can be mapped to the transport channel UL-SCH): The MAC entity of the UE may receive the UL control message/information/signals on the logical channel CCCH. After the processing in the MAC entity of the UE, the MAC entity of the UE may transfer the processed UL control message/information/signals via the transport channel UL-SCH to the lower layer (e.g., the PHY layer of the UE). For example, the RRC layer of the UE may transmit the UL RRC message such as RRC Resume Request message, RRC Reestablishment Request message, RRC Setup Request message and RRC System Information Request message, via the logical channel CCCH mapped to the transport channel UL-SCH, to the lower layers of the UE.

If the UE is configured with inter-cell beam management or when the UE is performing the inter-cell beam management operation or when the UE performs the inter-cell mobility, the UE may transmit the message/information/signals to or receive message/information/signals from a TRP associated with a PCI different from the PCI of the serving cell and/or a TRP associated with the PCI of the serving cell. The PCI that the TRP is associated with may belong to another cell, e.g., a cell with a TRP associated with a PCI different from the PCI of the serving cell. For the ease of illustration, such another cell may be referred to as “a target cell” or “a target serving cell”.

In intra-node scenarios (e.g., in a Carrier Aggregation (CA) case), the UE may apply the same MAC entity of the UE to the serving cell and to the target serving cell. The serving cell and the target serving cell may be operated by the same network node (e.g., master node or a BS), but not limited to.

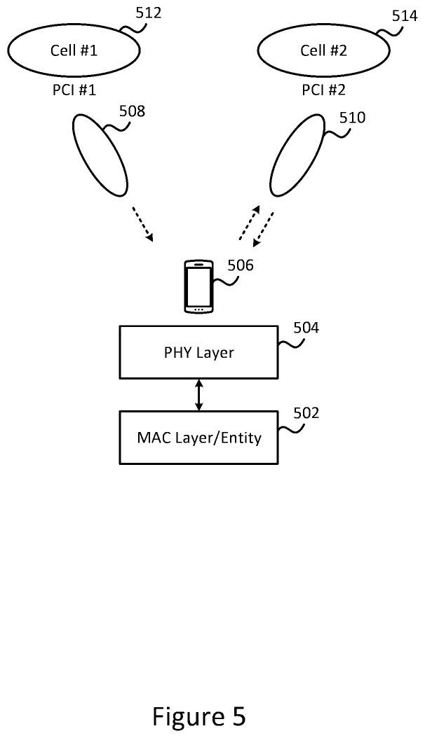

FIG. 5 is a schematic diagram illustrating an intra-node scenario, according to an example implementation of the present disclosure. As illustrated in FIG. 5, the MAC layer (entity) 502, as well as the Physical (PHY) layer 504, of the UE 506 may process the message/information/signals transmitted to or received from the TRP 508 associated with the serving cell 512 and the TRP 510 associated with a Physical Cell Identity (PCI) different from the PCI of the serving cell 512. The TRP 510 may be associated with the target serving cell 514 (e.g., Cell #2). From the UE's perspective, when the UE 506 is configured with inter-cell beam management or when the UE 506 is performing inter-cell beam management or when the UE 506 performs the inter-cell mobility, the UE 506 may receive non-UE-dedicated channels/signals via the TRP 508 associated with the PCI (e.g., PCI #1) of the serving cell 512 and transmit/receive UE-dedicated channels/signals via the TRP 510 associated with a PCI (e.g., PCI #2) different from the PCI (e.g., PCI #1) of the serving cell 512.

The single TRP operation and inter-cell beam management may be applied together. In another implementation, the UE may receive non-UE-dedicated channels/signals via the TRP 508 associated with the PCI of the serving cell 512 (e.g., Cell #1) and transmit/receive UE-dedicated channels/signals via the TRP 510 associated with a PCI different from the PCI of the serving cell and/or the TRP 508 associated with the PCI of the serving cell. The mTRP operations and inter-cell beam management may be applied together.

A serving cell and a target serving cell may operate on the same frequency band or different frequency bands. If the serving cell and the target serving cell operate on the same frequency, they are intra-frequency cells. If the serving cell and the target serving cell operate on different frequency bands, they are inter-frequency cells. The TRP of the serving cell and the TRP of the target serving cell may be spatial multiplexing. If they operate on different component carriers, the UE may perform CA between the serving cell and the target serving cell, where the serving cell may be the primary cell and the target serving cell may be the secondary cell.

When the functional split technique is applied in the network deployment, a network node (e.g., a BS) may include one Central Unit (CU) and several Distributed Units (DUs). A CU is a logical node hosting RRC, Service Data Adaptation Protocol (SDAP) and Packet Data Convergence Protocol (PDCP) protocols of the gNB or RRC and PDCP protocols of the en-gNB that controls the operation of one or more DUs. A DU is a logical node hosting Radio Link Control (RLC), MAC and PHY layers of the gNB or en-gNB, and its operation is partly controlled by gNB-CU. One DU may support one or multiple cells. The CU may connect to the several DUs via F1 interfaces. The intra-node inter-cell scenario may be further classified into (1) intra-CU intra-DU case and (2) intra-CU inter-DU case.

In an intra-CU intra-DU case, serving cells (e.g., the source serving cell, the target serving cell) may belong to the same DU and the same CU. In an intra-CU inter-DU case, one serving cell may be supported by one DU while the other serving cell may be supported by the other DU. Both serving cells may be supported by the same CU.

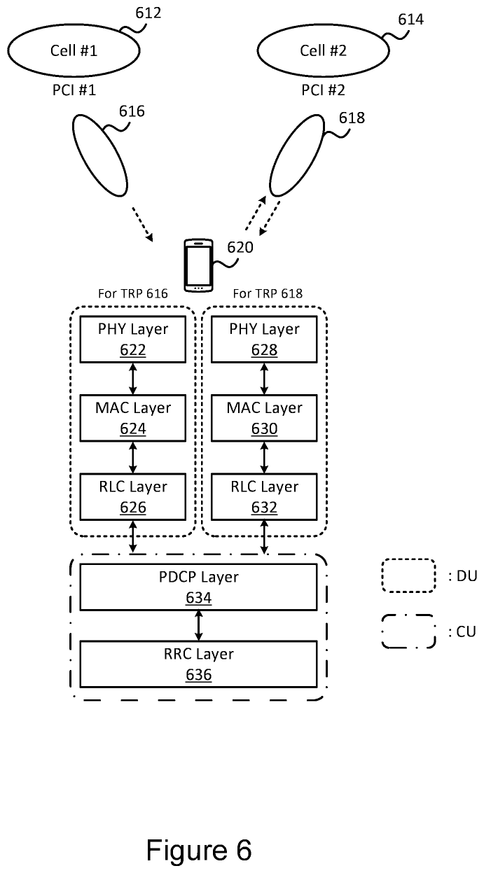

FIG. 6 is a schematic diagram illustrating an intra-CU inter-DU case, according to an example implementation of the present disclosure. As illustrated in FIG. 6, the serving cell 612 (e.g., Cell #1), associated with the TRP 616, may be supported by one DU (e.g., corresponding to the PHY layer 622, the MAC layer (entity) 624, and the RLC layer 626 of the UE 620), and another serving cell 614 (e.g., Cell #2), associated with the TRP 618, may be supported by a different DU (e.g., corresponding to the PHY layer 628, the MAC layer (entity) 630, and the RLC layer 632 of the UE 620), with both serving cells 612 and 614 being supported by the same CU (e.g., corresponding to the PDCP layer 634 and RRC layer 636 of the UE 620). The TRP 616 may be associated with the PCI (e.g., PCI #1) of the serving cell 612. The TRP 618 may be associated with a PCI (e.g., PCI #2) different from the PCI (e.g., PCI #1) of the serving cell 612. For example, the TRP 618 may be associated with the PCI of the (target) serving cell 614.

In inter-node scenarios (e.g., in dual-connectivity (DC) cases), the UE may apply one MAC entity of the UE to process the message/information/signals received from or transmitted to the serving cell and apply another MAC entity of the UE to process the message/information/signals received from or transmitted to the target serving cell, respectively.

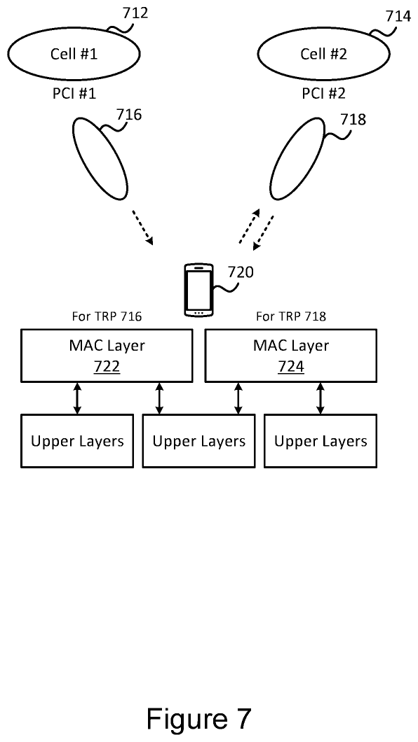

FIG. 7 is a schematic diagram illustrating an inter-node scenario, according to an example implementation of the present disclosure. As illustrated in FIG. 7, different MAC entities of the UE 720 (e.g., the MAC layer (entity) 722 and the MAC layer (entity) 724) may process the message/information/signals transmitted to or received from the TRP 716 of the serving cell 712 (e.g., Cell #1) and the TRP 718 of another serving cell 714 (e.g., Cell #2). The TRP 718 may also be considered as a TRP associated with a PCI (e.g., PCI #2) different from the PCI (e.g., PCI #1) of the serving cell 714. The serving cell 714 may also be referred to as a target serving cell.

The serving cell and the target serving cell may be operated by different network nodes (e.g., one by the master node and the other by the secondary node), but not limited to. From the UE's perspective when the UE 720 is configured with inter-cell beam management or when the UE 720 is performing inter-cell beam management, the UE 720 may receive non-UE-dedicated channels/signals via the TRP 716 associated with the PCI of the serving cell 712 (e.g., Cell #1) and transmit/receive UE-dedicated channels/signals via the TRP 718 associated with a PCI different from the PCI of the serving cell 712. The single TRP operation and inter-cell beam management may be applied together.

In another implementation, the UE 720 may receive non-UE-dedicated channels/signals via the TRP 716 associated with the PCI of the serving cell 712 (e.g., Cell #1) and transmit/receive UE dedicated channels/signals via the TRP 718 associated with a PCI different from the PCI of the serving cell 712 and/or a TRP (e.g., the TRP 716) associated with the PCI of the serving cell 712. The mTRP operations and inter-cell beam management may be applied together. For example, Cell #1 may be associated with two TRPs while Cell #2 may be associated with a single TRP.

The serving cell 712 and the target serving cell 714 may operate on the same frequency band or different frequency bands. If the serving cell and the target serving cell operate on the same frequency, they are intra-frequency cells. If the serving cell and the target serving cell operate on different frequency bands, they are inter-frequency cells. The TRP 716 of the serving cell and the TRP 718 of the target serving cell 714 may be spatial multiplexing. If the serving cell 712 and the target serving cell 714 operate on different frequency carriers, the UE may perform Multi-Connectivity (MC) or Dual-Connectivity (DC) between the serving cell 712 and the target serving cell 714, where the serving cell 712 may be the special cell or the primary cell, and the target serving cell 714 may be the special cell, the primary secondary cell or the secondary cell.

It should be noted that the methods/mechanisms/approaches described in the present disclosure, including but not limited to methods 100, 200, 300, and 400, can be applied to the inter-node, intra-node, intra-cell or inter-cell scenarios/cases that are mentioned in this disclosure.

According to some aspects of the present disclosure, if the UE applies mTRP UL operations (e.g., mTRP PUCCH repetition, mTRP PUSCH repetition) in a single cell, the UE may apply UL transmission toward two TRPs with corresponding beam directions. Each corresponding beam direction may be associated with a spatial relation information, an UL TCI state or a joint TCI state.

The two beam directions may be associated with different spatial relation information, different SRS resource sets, different precoding information and number of layers, different panels, different UL TCI states and/or different joint TCI states.

If the UE is configured with spatial relation information and/or the UE is capable to support the spatial relation information, each corresponding beam direction may be associated with a spatial relation information.

If the UE is configured with the unified TCI framework (e.g., the unified TCI configuration) and/or the UE is capable to support the unified TCI framework, each corresponding beam direction may be associated with a TCI state (e.g., an UL TCI state, a DL TCI state, a joint TCI state). If the UE is configured with the unified TCI type set to ‘separate.’ the UE is operating in the separate mode, and each corresponding beam direction may be associated with an UL TCI state. If the UE is configured with the unified TCI type set to ‘jointU'LDL,’ the UE is operating in the joint mode, each corresponding beam direction may be associated with a unified TCI state.

The UE may receive one or more sets of UL power control parameters in the RRC messages (e.g., RRC Setup message, RRC Resume message, RRC Reconfiguration message) from the serving cell (e.g., a PCell). Each set of UL power control parameters may be identified an ID. For example, each set of UL power control parameters may be associated with a specific power control parameter set ID, PCI, TCI state ID, panel ID, cell ID, search space ID, CORESET ID, CORESETPoolIndex or TRP specific ID but not limited to. Each set of UL power control parameters may include parameters required for UL open-loop or closed-loop power control. After receiving the set of UL power control parameters, the UE may configure itself with the received set of UL power control parameters. It is noted that the set of UL power control parameters may be (equal to) a set of PUCCH power control parameters. Additionally, the UE may receive the RRC message(s) from a TRP, as illustrated in FIG. 2, where each set of UL power control parameters may correspond to a respective UL power control configuration (e.g., the first UL power control configuration or the second UL power control configuration). The terms “set of UL power control parameters” and “UL power control configuration” can be used interchangeably in the present disclosure.

If the set of UL power control parameters is associated with PUCCH, the UE may apply and/or configure the set of UL power control parameters for PUCCH transmission. The set of UL power control parameters may be associated with one or more than one DCI field. The set of UL power control parameters may be associated with one or more than one DCI format. Each of the set of UL power control parameters may be associated with a CORESET, a search space, a CORESET group, a search space group, and/or a CORESET pool.

If the set of UL power control parameters is associated with PUSCH, the UE may apply and/or configure the set of UL power control parameters for PUSCH transmission. If a set of UL power control parameters is associated with an SRS resource set, the UE may apply and/or configure one or more sets of UL power control parameters associated with the SRS resource set for the corresponding PUSCH transmission. If the set of UL power control parameters is associated with PRACH, the UE may apply and/or configure the set of UL power control parameters for PRACH transmission. If the set of UL power control parameters is associated with SRS, the UE may apply and/or configure the set of UL power control parameters for SRS transmission. If a set of UL power control parameters is associated with an SRS resource set, the UE may apply and/or configure the set of UL power control parameters for an SRS transmission according to the configuration of the SRS resource set. If a set of UL power control parameters is associated with an SRS resource, the UE may apply and/or configure the set of UL power control parameters for an SRS transmission according to the configuration of the SRS resource.

The UE may receive an RRC message or system information including cell-group-specific configurations (e.g., CellGroupConfig IE) from a serving cell (e.g., a PCell in case that the UE is configured with carrier aggregation). Each cell-group-specific configuration may include a cell group identity and several cell-group-specific parameters for the identified cell group, to configure the UE with an MCG or an SCG. For example, a cell group identity may identify an MCG or an SCG. The cell-group-specific configuration including a cell group identity identifying an MCG may configure the UE with MCG-specific configurations. The cell-group-specific configuration including a cell group identity identifying an SCG may configure the UE with SCG-specific configurations. The RRC message including the cell-group-specific configuration(s) and the RRC message illustrated in FIG. 2 may be the same signaling or different signaling.

Upon/after the UE receives the RRC message or system information including cell-group-specific configurations, the UE may apply configurations included in the cell-group-specific configurations. Upon/after the UE receives the cell-group-specific configuration, the UE may further determine whether the cell-group-specific configuration includes a special cell configuration (e.g., SpCellConfig IE). If the UE determines that the cell-group-specific configuration includes a special cell configuration, the UE may configure itself with a SpCell for the corresponding cell group, which is identified by a cell group identity in the cell group configuration that includes the corresponding special cell configuration. Upon/after the UE receives the cell-group-specific configuration, the UE may determine whether the cell-group-specific configuration includes a list of SCell configurations to be added or modified (e.g., sCellToAddModList IE). If the UE determines that the cell-group-specific configuration includes a list of SCell configurations to be added or modified, the UE may perform SCell addition/modification procedures based on the list of SCell configurations.

The special cell configuration may include serving-cell-specific MAC and PHY parameters for a SpCell of a cell group. The special cell configuration for a SpCell of a cell group is included in the cell-group-specific configuration that includes information of the corresponding cell group. The special cell configuration may further include a serving cell configuration (e.g., ServingCellConfig IE) for the SpCell.

The list of SCell configurations to be added or modified may include configurations/parameters for SCells. Each SCell configuration (e.g., SCellConfig IE) may include the serving cell configuration for the corresponding SCell, identified by an SCell index included in this SCell configuration. The serving cell configuration may include the configuration of the corresponding serving cell. The UE may regard an SCell as a serving cell. For example, upon/after the UE applies the serving cell configuration for an SCell, the UE may regard the SCell as a serving cell. The UE may regard an SpCell as a serving cell. For example, upon/after the UE applies the serving cell configuration for a SpCell, the UE may regard the SpCell as a serving cell.

The serving cell configurations may be used to configure (e.g., add or modify) the UE with a serving cell, where the UE receives and/or applies the serving cell configurations, and the serving cell may be the SpCell or an SCell of an MCG or SCG. The UE may receive the serving cell configuration from a serving cell that is associated with the serving cell configuration. The UE may receive the serving cell configuration from a first serving cell, where the first serving cell is different from a second serving cell that is associated with the serving cell configuration.

Upon/after the UE receives the RRC message or system information including serving cell configurations, the UE may determine whether the UE is in RRC_CONNECTED state and whether a timer (e.g., T311 timer) is running. If the UE determines that the UE is in RRC_CONNECTED and the timer is not running, the UE may use the configurations included in the serving cell group configuration.

The UE may receive the RRC message from a SpCell of an MCG or an SCG. In the mTRP operations, the UE may receive the RRC message from a SpCell of an MCG or an SCG through a TRP (e.g., the first TRP or the second TRP). The UE may receive the system information from a SpCell of an MCG.

The parameters in the serving cell configuration may be mostly UE-specific but partly also cell-specific (e.g., in additionally configured bandwidth parts). The reconfiguration between a PUCCH and a PUCCHless SCell may be only supported using an SCell release and add. The parameters in the serving cell configuration used for the UL power control may include at least one of the following: unified TCI state type indication, a list of uplink power control configurations to be configured, a list of uplink power control configurations to be released, a list of additional PCI configurations, or UL BWP configurations. In some implementations, the UE may receive the parameters through an additional or existing action as part of any of the previously mentioned methods 100, 200, 300, and 400.

The following illustrates the exemplary details of the parameters.

Unified TCI state type indication (e.g., unifiedtci-StateType IE): This indication (e.g., the first unified TCI state type indication or the second unified TCI state type indication) may indicate the unified TCI state type the UE is configured for this serving cell. The value “separate” may mean that the separate mode is configured, and this serving cell is configured with DLorJoint-TCIState for DL TCI state and UL-TCIState for UL TCI state. The value “joint” may mean that the joint mode is configured, and this serving cell is configured with DLorJoint-TCIState for joint TCI state for UL and DL operation. It is noted that “this serving cell” may be associated with the serving cell configuration. In another implementation, “this serving cell” may be configured by the serving cell configuration. It is noted that “this serving cell” may be the serving cell where the UE receives the unified TCI state indication or another cell where the UE does not receive the unified TCI state indication.

In some implementations, the UE may apply the unified TCI state type corresponding to the serving cell for the unified TCI state type corresponding to the target serving cell. For example, after the UE receives the unified TCI state type indication corresponding to the serving cell, the UE may apply the unified TCI state type corresponding to the serving cell for the target serving cell. In such implementations, the unified TCI state type of the serving cell and the target serving cell may be determined based on single unified TCI state type indication. For example, a UE may be indicated the unified TCI state type applied for the serving cell is ‘UL-TCIState,’ then the UE may also apply the same unified TCI state type configured for the serving cell, e.g., ‘UL-TCIState,’ for the target serving cell. The unified TCI state type may be configured by RRC signaling, MAC CE or DCI from the serving cell or target serving cell.

In some implementations, the UE may receive respective unified TCI state type indication (e.g., the second unified TCI state type indication) for the target serving cell, e.g., via a serving cell configuration specific for the target serving cell.

A list of UL power control configurations to be configured (e.g., added, modified) (e.g., Uplink-PowerControlToAddModList IE): This list of UL power control configurations to be configured (e.g., added or modified) may configure (e.g., add, modify) UL power control parameters for PUSCH, PUCCH and SRS when the unified TCI state type indication (e.g., unifiedtci-StateType IE) is configured. When the list of UL power control configurations is configured to the UE, the network may not configure other UL power control parameters configured in other IEs such as PUCCH-PowerControl IE, PUSCH-PowerControl IE or SRS-Config IE for the UE.

Each UL power control configuration (e.g., uplink-powerControl IE) may be used to configure UE-specific power control parameter for PUSCH, PUCCH and SRS for the serving cell associated with the serving cell configuration that includes such UL power control configuration. Each UL power control configuration may include an UL power control identity to identify such UL power control configuration, a P0 alpha set configuration for PUCCH, a P0 alpha set configuration for PUSCH, and a P0 alpha set configuration for SRS. The P0 alpha set configuration may include a P0 value, an alpha value and a close loop index used for UL power control for the corresponding channels (e.g., PUCCH, PUSCH) or RSs (e.g., SRS).

If the list of UL power control configurations configured by the NW includes only one power control configuration, the UE may directly apply that power control configuration for UL transmission. If the list of UL power control configurations configured by the NW includes more than one power control configurations and the UL transmission is configured with multi-TRP based UL transmission (e.g., intra-cell multi-TRP UL transmission or inter-cell multi-TRP UL transmission), the UE may directly apply the more than one power control configurations for the UL transmissions toward more than one TRPs.

A list of UL power control configurations to be released (e.g., Uplink-PowerControlToReleaseList IE): This list of UL power control configurations to be released may release a list of UL power control configuration for the UE. Each UL power control configuration to be released may be identified by an UL power control identity. Thus, the list of UL power control configurations to be released may include a list of UL power control identities identifying the UL power control configurations to be released.

A list of additional PCI configurations (e.g., AdditionalPCIList IE): The list of additional PCI configurations may include a list of timing information for the additional SSBs associated with different PCIs than the PCI of the serving cell. It is noted that the serving cell is associated with the serving cell configuration that includes the list of additional PCI configurations.

Each additional PCI configuration (e.g., SSB-MTC-AdditionalPCI IE) may be used to configure measurement timing configurations, e.g., timing occasions at which the UE measures SSBs, where the SSBs are associated with a different PCI from the PCI of the serving cell. Each additional PCI configuration may include at least one of the following: (1) a PCI that is different from the PCI of the serving cell, (2) a PCI index, (3) periodicity of the SSBs to be measured, (4) the time domain positions of the transmitted SS-blocks in a half frame with SSBs, and (5) Average Energy Per Resource Elements (EPRE) of the resources elements that carry secondary synchronization signals in dBm that the network uses for SSB transmission. The information in an additional PCI configuration is associated with the SSBs to be measured indicated in the additional PCI configuration.

UL BWP configurations (e.g., BWP-UplinkDedicated IE): Each UL BWP configuration may correspond to an initial BWP of this serving cell or an additional BWP of this serving cell for the UE. Each UL BWP may include UE-specific parameters to configure an UL BWP for the UE in this serving cell, where this serving cell is associated with the serving cell configuration that includes the UL BWP configuration. Each UL BWP configuration may include the UL TCI state information (e.g., ul-TCIState IE) and the corresponding UL power control configuration.

The UL TCI state information (e.g., ul-TCI-StateList IE) may be an explicit list of UL TCI state configurations (e.g., explicitlist IE) or a referenced unified TCI state list (e.g., unifiedTCI-StateRef IE). The UL TCI state information may indicate the UE of the applicable UL TCI states for PUCCH, PUSCH and SRS. The explicit list of UL TCI state configurations may include a list of UL TCI state configurations (e.g., TCI-UL-State IE, DLorJoint-TCIState IE) to be configured (e.g., added, modified) and a list of UL TCI state identities (e.g., TCI-UL-State-Id IE, DLorJoint-TCIState-Id IE) identifying the corresponding UL TCI state configurations to be released.

Each UL TCI state configuration (e.g., TCI-UL-State IE, DLorJoint-TCIState IE) may be associated with one or two DL or UL RSs with a corresponding quasi-colocation (QCL) type. Each UL TCI state configuration may include an UL TCI state identity (e.g., TCI-UL-State-Id IE, DLorJoint-TCIState-Id IE) to identify such UL TCI state configuration. For example, if the UE is indicated with the unified TCI state type indication of ‘separate,’ the UE may apply the UL TCI state configuration, TCI-UL-State IE. If the UE is indicated with the unified TCI state type indication of ‘separate,’ the UL TCI state configuration may include the UL TCI state identity, TCI-UL-State-Id IE. If the UE is indicated with the unified TCI state type indication of ‘joint,’ the UE may apply the UL TCI state configuration, DLorJoint-TCIState IE. If the UE is indicated with the unified TCI state type indication of ‘joint,’ the UL TCI state configuration may include the UL TCI state identity, DLorJoint-TCIState-Id IE. In this case, the terms ‘UL TCI state configuration’ and ‘DLorJoint TCI state configuration’ may be used interchangeably.

Each UL TCI state configuration (e.g., TCI-UL-State IE, DLorJoint-TCIState IE) may include a serving cell identity (e.g., ServCellIndex IE, servingCellId IE). This serving cell identity may identify a UE's serving cell where an RS indicated in this UL TCI state configuration is configured. In case that the UL TCI state configuration does not include a serving cell identity (in other words, the serving cell identity is absent in the UL TCI state configuration), it implicitly means that the serving cell is the serving cell where the (UL) TCI state is configured. For example, when the QCL type is configured with specific types (e.g., type C or type D), the RS indicated in the UL TCI state configuration may be located on a serving cell different from the serving cell where the (UL) TCI state is configured. For another example, when the QCL type is configured with specific types, the RS indicated in the UL TCI state configuration may be located on a serving cell the same as the serving cell where the (UL) TCI state is configured. The UE may determine the UL TX spatial filter based on the reference RS configured in the UL TCI state configuration (e.g., TCI-UL-State IE, DLorJoint-TCIState IE).

Each UL TCI state configuration (e.g., TCI-UL-State IE, DLorJoint-TCIState IE) may include a BWP identity. The BWP identity may identify a DL BWP where a DL RS (e.g., CSI-RS) indicated in the same UL TCI state configuration is located. Alternatively, the BWP identity may identify an UL BWP where an UL RS (e.g., SRS) indicated in the same UL TCI state configuration is located. Thus, the interpretation of the BWP identity may correspond to the RS indicated in the same UL TCI state configuration. If a CSI-RS or an SRS is indicated in this UL TCI state configuration, the UL TCI state configuration is required to include a BWP identity. If neither a CSI-RS nor an SRS is indicated in this UL TCI state configuration, the UL TCI state configuration is NOT required to include a BWP identity. Based on the RS, the UE may derive the corresponding QCL type for this UL TCI state. For example, the QCL information the UE refers to for this UL TCI state may include an RS, which is the same as the RS indicated in this UL TCI state configuration.

Each UL TCI state configuration (e.g., TCI-UL-State IE, DLorJoint-TCIState IE) may indicate an RS. The RS may be an SSB, a CSI-RS or an SRS. Thus, each UL TCI state configuration (e.g., TCI-UL-State IE, DLorJoint-TCIState IE) may include an SSB index to indicate an SSB, a CSI-RS resource ID to indicate a CSI-RS, or an SRS resource ID to indicate an SRS. Each UL TCI state configuration (e.g., TCI-UL-State IE, DLorJoint-TCIState IE) may include additional PCI (e.g., additionalPCI IE, AdditionalPCIIndex IE) to indicate the physical cell identities of the SSBs.

A referenced unified TCI state list (e.g., unifiedTCI-StateRef IE) may provide information of the serving cell and UL BWP where the applicable UL TCI states applicable to this UL BWP are defined.

The corresponding UL power control configuration (e.g., uplink-powerControl IE) may include power control parameters for PUCCH, PUSCH and SRS when the UE is configured with the unified TCI state type indication for this serving cell. It is noted that the corresponding UL power control configuration is present only when the UL power control is not configured for any UL TCI state and DLorJoint-TCIState. In other words, if the UL power control is configured for any UL TCI state and DLorJoint-TCIState, the UE may not expect to receive the corresponding UL power control configuration in this UL BWP configuration. For example, if the UE has received the list of UL power control configurations to be configured in the serving cell configuration but not in the UL BWP configurations, the UE may not receive the corresponding UL power control configuration in the UL BWP configurations for the same serving cell. Alternatively, if the UE does not receive the list of UL power control configurations to be configured in the serving cell configuration, the UE may (expect to) receive the corresponding UL power configuration in the UL BWP configuration for the same serving cell.

For UL transmission enhancement, the UL power control can be improved by configuring the UE with specific UL power control configuration for each corresponding TRP. In other words, the UE may apply the TRP-specific UL power control to enhance the UL data rate and performance. As illustrated in FIG. 1, the UE may employ a TRP-specific UL power control by applying respective TCI states and power control configurations for each TRP.

Considering the TRP-specific UL power control in the unified TCI framework, the transmission of the PUCCH resources, PUSCH resources and SRS resources associated with the same TRP or with the same UL TCI may apply the same UL power control configuration. As illustrated in FIG. 1, the UE may apply the first TCI state and the first UL power control configuration, which are associated with the first TRP, to perform the first UL transmission toward the first TRR, and apply the second TCI state and the second UL power control configuration, which are associated with the second TRP, to perform the second UL transmission toward the second TRP.

The UL power control configuration (e.g., the first UL power control configuration or the second UL power control configuration) may include at least one of the following: an UL power control identity to identify such UL power control configuration, a P0 alpha set configuration for PUCCH, a P0 alpha set configuration for PUSCH, or a P0 alpha set configuration for SRS. The P0 alpha set configuration may include at least one of the following: a P0 value, an alpha value, or a close loop index used for UL power control for the corresponding channels (e.g., PUCCH, PUSCH) or RSs (e.g., SRS).

In the mTRP operations, the UL transmissions toward multiple TRPs with corresponding beam directions associated with different TCI states. Each TRP may be associated with a TCI state. The UE may apply a specific TCI state for the UL transmission toward the associated TRP. Thus, the TRP-specific UL power control may also be regarded as a TCI-state-specific UL power control approach.

The TRP-specific UL power control approach may be applied for the intra-cell mTRP operations, inter-cell mTRP operations, inter-cell beam management, and/or inter-cell mobility. In the case of mTRP operations (e.g., the UE performs UL transmission toward more than one TRPs (e.g., two TRPs)), the UE may apply a specific UL power control for each corresponding TRP.

For example, the UE may apply a specific UL power control configuration for each corresponding TRP in the same cell. For example, the UE may apply a specific UL power control configuration of a corresponding TRP in one cell and another specific UL power control configuration of another corresponding TRP in another cell. The cells may belong to the same network node or belong to different network nodes.

The TRP-specific UL power control approach may be used for (but not limited to) inter-cell mTRP operations, inter-cell beam management and inter-cell mobility. The inter-cell operation may be further classified into two cases: intra-node inter-cell case and inter-node inter-cell case.

In the intra-cell case, the UE may be served by at least one serving cells and the at least two cells may belong to the same BS (or network node). Furthermore, when the UE performs mTRP operations in an intra-cell case, the UE may receive/transmit signals from/to at least one TRP of a serving cell and receive/transmit signals from/to at least one TRP of the same serving cell. For example, when the UE performs mTRP operations in intra-cell case and the number of TRP is two, the UE may receive/transmit signals from/to one TRP associated with a serving cell and receive/transmit signals from/to another TRP associated with the same serving cell.

In the intra-node inter-cell case, the UE may be served by at least two cells and the at least two cells may belong to the same BS (or network node). For example, when the UE can perform carrier aggregation, the UE may connect to a BS (or network network) on different component carriers, where the UE is served by a serving cell on each component carrier. Furthermore, when the UE performs mTRP operations in an intra-node inter-cell case, the UE may receive/transmit signals from/to at least one TRP of a serving cell and receive/transmit signals from/to at least one TRP of another serving cell. For example, when the UE performs mTRP operations in intra-node inter-cell case and the number of TRP is two, the UE may receive/transmit signals from/to one TRP associated with a serving cell and receive/transmit signals from/to another TRP associated with another serving cell.

In the inter-node inter-cell case, the UE may be served by at least two cells and the at least two cells may belong to different BSs (or network nodes). For example, when the UE can perform multi-connectivity (e.g., dual connectivity), the UE may connect to at least two BSs (or network nodes) on different frequency carriers. The UE may connect to a master BS (e.g., a master network node) on one frequency carrier, where the UE is served by at least one serving cell on the frequency carrier. The UE may simultaneously connect to a secondary BS (e.g., a secondary network node) on another frequency carrier, where the UE is served by at least one serving cell on another frequency carrier. Furthermore, when the UE performs mTRP operations in an inter-node inter-cell case, the UE may receive/transmit signals from/to at least one TRP of a serving cell belonging to a master node and receive/transmit signals from/to at least one TRP of another serving cell belonging to a secondary node. For example, when the UE performs mTRP operations in an intra-node inter-cell case and the number of TRP is two, the UE may receive/transmit signals from/to one TRP associated with a serving cell belonging to a master node and receive/transmit signals from/to another TRP associated with another serving cell belonging to a secondary node.

When the UE can perform multi-connectivity and carrier aggregation, the UE may utilize simultaneously the proposed designs for the intra-node inter-cell case and the designs for the inter-node inter-cell case.

According to the TRP-specific UL power control approach, the UE may receive the UL power control configurations for a (target) serving cell (e.g., Cell #2) from another serving cell (e.g., Cell #1, a source serving cell). Cell #2 may refer to a target serving cell. Cell #1 may refer to a source serving cell. It is possible that the UE may receive an UL power control configuration for a TRP and another UL power control configuration for another TRP from the same serving cell, wherein the two TRPs are associated with the same serving cell.

As discussed earlier, in action 202 of FIG. 2, the UE may receive an RRC message from the first TRP, where the RRC message may include a set of UL power control configurations associated with the second TRP, where the set of UL power control configurations may include the second UL power control configuration. For example, the UE may receive the RRC message including the set of UL power control configurations for the target serving cell (e.g., associated with the second TRP) from the source serving cell (e.g., associated with the first TRP). Upon/after receiving the RRC message, the UE may apply an UL power control configuration (e.g., the second UL power control configuration associated with the second TRP) in the set of UL power control configurations to perform UL transmission to the target serving cell.

Additionally, in action 204 of FIG. 2, the UE may further receive a MAC CE from one of the first TRP and the second TRP, where the MAC CE may indicate to the UE to apply the second UL power control configuration among the set of UL power control configurations to perform the second UL transmission. For example, the UE may receive the MAC CE from the source serving cell, where the MAC CE is used to indicate to the UE to apply/use the specific UL power control configuration indicated in the RRC message from the source serving cell. If the MAC entity of the UE receives the MAC CE, the MAC entity of the UE may indicate to the lower layers of the UE (e.g., PHY layer of the UE) to apply the information regarding the MAC CE. In another example, the UE may receive the MAC CE from the target serving cell. The MAC CE is used to indicate to the UE to apply the specific UL power control configuration indicated in the RRC message from the source serving cell. If the MAC entity of the UE receives the MAC CE, the MAC entity of the UE may indicate to the lower layers of the UE (e.g., PHY layer of the UE) to apply the information regarding the MAC CE.

In some implementations, the UE may further receive more than one MAC CEs from the source serving cell and the target serving cell. Each MAC CE is used to indicate to the UE to apply the specific UL power control configuration indicated in the RRC message from the source serving cell, where the specific UL power control configuration may refer to the same or different serving cells. The UE may apply the information indicated by the respective MAC CE corresponding to different serving cells.

In some implementations, the UE may receive a list of UL power control configurations (e.g., a list of a set of UL power control configurations, where the set of UL power control configurations may correspond to (but not limited to) the set of UL power control configurations described with referenced to FIG. 2) for the target serving cell from the source serving cell. In case that the list only includes one UL power control configuration for the target serving cell, the UE (e.g., the RRC layer of the UE, the MAC layer of the UE) may indicate to the lower layers of the UE (e.g., the PHY layer of the UE, the MAC layer of the UE) to apply that UL power control configuration for the UL transmission corresponding to the target serving cell.

In some implementations, the UE may receive a list of UL power control configurations (e.g., a list of a set of UL power control configurations, where the set of UL power control configurations may correspond to (but not limited to) the set of UL power control configurations described with referenced to FIG. 2) for the target serving cell and the source serving cell from the source serving cell. In case that the list (only) includes one UL power control configuration for the target serving cell and one UL power control configuration for the source serving cell, the UE (e.g., the RRC layer of the UE, the MAC layer of the UE) may indicate to the lower layers of the UE (e.g., the PHY layer of the UE, the MAC layer of the UE) to apply the UL power control configuration associated with the target serving cell for the UL transmission corresponding to the target serving cell and the UL power control configuration associated with the source serving cell for the UL transmission corresponding to the source serving cell.

In some implementations, the UE may receive the RRC message including the UL power control configurations (e.g., a set of UL power control configurations, which may correspond to (but not limited to) the set of UL power control configurations described with referenced to FIG. 2) for the target serving cell from the target serving cell. Upon/after receiving the RRC message, the UE may apply the UL power control configurations for the target serving cell. The UE may further receive the MAC CE from the source serving cell. The MAC CE is used to indicate to the UE to apply the specific UL power control configuration indicated in the RRC message from the target serving cell. If the MAC entity of the UE receives the MAC CE, the MAC entity of the UE may indicate to the lower layers of the UE (e.g., PHY layer of the UE) to apply the information regarding the MAC CE. In another example, the UE may receive the MAC CE from the target serving cell, where the MAC CE is used to indicate to the UE to apply the specific UL power control configuration indicated in the RRC message from the target serving cell. If the MAC entity of the UE receives the MAC CE, the MAC entity of the UE may indicate to the lower layers of the UE (e.g., PHY layer of the UE) to apply the information regarding the MAC CE.

In some implementations, the UE may receive more than one MAC CEs from the source serving cell and the target serving cell. Each MAC CE is used to indicate to the UE to apply the specific UL power control configuration indicated in the RRC message from the target serving cell, where the specific UL power control configuration may refer to the same or different serving cells. The UE may apply the information indicated by the respective MAC CE corresponding to different serving cells.

In some implementations, the UE may receive a list of UL power control configurations for the target serving cell from the target serving cell. In case the list only includes one UL power control configuration for the target serving cell, the UE may indicate to the lower layers of the UE (e.g., PHY layer of the UE) to apply that UL power control configuration for the UL transmission corresponding to the target serving cell.

In some implementations, the UE receives a list of UL power control configurations for the target serving cell and the source serving cell from the target serving cell. In case that the list (only) includes one UL power control configuration for the target serving cell and one UL power control configuration for the source serving cell, the UE (e.g., the RRC layer of the UE, the MAC layer of the UE) may indicate to the lower layers of the UE (e.g., the PHY layer of the UE, the MAC layer of the UE) to apply the UL power control configuration associated with the target serving cell for the UL transmission corresponding to the target serving cell and the UL power control configuration associated with the source serving cell for the UL transmission corresponding to the source serving cell.

When the functional split technique is applied, within a BS (or a network node), one central unit (CU) may connect to several distributed unit (DU). If the functional split technique is applied for the intra-node inter-cell case, the situation can be further classified into two scenarios: (a) an intra-CU intra-DU inter-cell scenario, and (b) an intra-CU inter-DU inter-cell scenario.

In an intra-CU intra-DU inter-cell scenario, the at least two serving cells may belong to the same DU and the same CU. That is, the UE may apply the same RRC layer, the same PDCP layer, the same RLC layer, the same MAC layer and the same PHY layer to connect to the at least two serving cells.

In an intra-CU inter-DU inter-cell scenario, the at least two serving cells may belong to different DUs but the same CU. That is, the UE may apply the same RRC layer, the same PDCP layer, different RLC layers, different MAC layers and different PHY layers to connect to the at least two serving cells.

The proposed methods (e.g., including the methods 100, 200, 300, and 400)/mechanisms described in the present disclosure may be applied to an intra-cell case, an intra-node inter-cell case, an intra-CU inter-DU case, an intra-CU intra-DU case, but not limited to. For example, after the UE determines that the UE is configured with (or is deployed in) an intra-cell scenario, an intra-node inter-cell scenario, an intra-CU inter-DU scenario and/or an intra-CU intra-DU scenario, the UE may perform the TRP-specific UL power control implementations and designs.

In some implementations, the UE may receive the RRC message (e.g., RRC Reconfiguration message) including the UL power control configurations for the target serving cell, from the source serving cell (or from the target serving cell) during RRC reconfiguration, after RRC connection setup, after RRC connection resume, during SCell addition/modification/release, and/or during handover.

The UL power control configurations for the target serving cell may be included in a serving cell configuration, where the serving cell configuration includes the serving cell identity/index of the target serving cell. The serving cell configuration may be included in a PCell configuration, e.g., if the target serving cell is a PCell to the UE. The serving cell configuration may be included in a SCell configuration, e.g., if the target serving cell is a SCell to the UE. The RRC message may include the PCell configuration, SCell configuration, serving cell configuration and/or the UL power control configurations for the target serving cell. If the UL power control configurations for the target serving cell are included in a serving cell configuration rather than in an UL BWP configuration, the UL power control configurations for the target serving cell may be cell-specific.

The UL power control configurations for the target serving cell may be included in an UL BWP configuration, where the UL BWP configuration is associated with the serving cell identity/index of the target serving cell. The UL BWP configuration may be included in a serving cell configuration. The serving cell configuration may be included in a PCell configuration, e.g., if the target serving cell is a PCell to the UE. The serving cell configuration may be included in a SCell configuration, e.g., if the target serving cell is a SCell to the UE. The RRC message may include the PCell configuration, SCell configuration, serving cell configuration, UL BWP configuration and/or the UL power control configurations for the target serving cell. If the UL power control configurations for the target serving cell are included in the UL BWP configuration, the UL power control configurations for the target serving cell may be BWP-specific.

In some implementations, the UE may receive the RRC message (e.g., RRC (Connection) Setup message) including the UL power control configurations for the target serving cell, from the source serving cell (or from the target serving cell) during RRC connection setup procedure. Specifically, the RRC message (e.g., RRC (Connection) Setup message) may not include the complete UL power control configurations for the target serving cell. The RRC message (e.g., RRC (Connection) Setup message) may include part of the UL power control configurations for the target serving cell.

In some implementations, the UE may receive the RRC message (e.g., RRC (Connection) Resume message) including the UL power control configurations for the target serving cell, from the source serving cell (or from the target serving cell) during RRC connection resume procedure. Specifically, the RRC message (e.g., RRC (Connection) Resume message) may not include the complete UL power control configurations for the target serving cell. The RRC message (e.g., RRC (Connection) Resume message) may include part of the UL power control configurations for the target serving cell.

In some implementations, after the UE receives the RRC message (e.g., RRC Reconfiguration message, RRC (Connection) Setup message, RRC (Connection) Resume message), the UE may apply and/or configure the UL power control configurations for the target serving cell, if exists.

In some implementations, after the UE receives the RRC message (e.g., RRC Reconfiguration message, RRC (Connection) Setup message, RRC (Connection) Resume message), the UE may apply and/or configure part of the UL power control configurations for the target serving cell, if exists.

In another implementation, upon/after the UE receives the RRC message (e.g., RRC Reconfiguration message, RRC (Connection) Setup message, RRC (Connection) Resume message), the UE may further determine whether the UE is in RRC_CONNECTED state and whether a timer (e.g., T311) is running. If the UE determines that the UE is in RRC_CONNECTED and the timer is not running, the UE may further apply and/or configure the configurations included in the serving cell group configuration.

In another implementation, upon/after the UE receives the RRC message (e.g., RRC Reconfiguration message, RRC (Connection) Setup message, RRC (Connection) Resume message), the UE may further determine whether the UE is in RRC_CONNECTED state and whether a timer (e.g., T311) is running. If the UE determines that the UE is in RRC_CONNECTED and the timer is not running, the UE may further apply and/or configure the UL power control configurations for the target serving cell, if exists.

In another implementation, upon/after the UE receives the RRC message (e.g., RRC Reconfiguration message, RRC (Connection) Setup message, RRC (Connection) Resume message), the UE may further determine whether the UE is in RRC_CONNECTED state and whether a timer (e.g., T311) is running. If the UE determines that the UE is in RRC_CONNECTED and the timer is not running, the UE may further apply and/or configure part of the UL power control configurations for the target serving cell, if exists.

In some implementations, upon/after the UE receives the RRC message including (part of) the UL power control configurations for the target serving cell, the UE may apply and/or configure the received (part of) the UL power control configurations for the target serving cell for the UL TCI states associated with the target serving cell. (Part of) The UL power control configurations for the target serving cell may be cell-specific or BWP-specific.

In some implementations, (part of) the UL power control configurations for the target serving cell may be associated with the serving cell ID of the target serving cell or associate with the serving cell index of the target serving cell. The serving cell ID may be a physical cell ID. The serving cell index may be a positive integer, e.g., from 1 to 3/4/7/8/15/16/31/32. It is noted that the serving cell ID of the target serving cell or the serving cell index of the target serving cell may be included in the UL BWP configuration or in the serving cell configuration, but not limited to. For example, (part of) the UL power control configurations for the target serving cell and the serving cell ID of the target serving cell may be in the same IE and in the same RRC message. For example, (part of) the UL power control configurations for the target serving cell and the serving cell index of the target serving cell may be in the same IE and in the same RRC message. For example, (part of) the UL power control configurations for the target serving cell and the serving cell ID of the target serving cell may be in the different IEs but in the same RRC message. For example, (part of) the UL power control configurations for the target serving cell and the serving cell index of the target serving cell may be in the different IEs but in the same RRC message.

In some implementations, (part of) the UL power control configurations for the target serving cell may be associated with the physical cell ID of the target serving cell or associate with the additional PCI index for the target serving cell (e.g., AdditionalPCIIndex IE). Furthermore, (part of) the UL power control configurations for the target serving cell may be associated with the serving cell ID of the source serving cell that transmits the RRC message. The additional PCI index may be a positive integer, e.g., from 1 to 3/7/15/31. It is noted that the physical cell ID of the target serving cell or the additional PCI index of the target serving cell may be included in the UL BWP configuration, in the serving cell configuration, in the UL TCI information or in the DLorJoint TCI information, but not limited to. For example, (part of) the UL power control configurations for the target serving cell and the serving cell ID of the source serving cell may be in the same IE and in the same RRC message. For example, (part of) the UL power control configurations for the target serving cell and the serving cell ID of the source serving cell may be in the different IEs but in the same RRC message. For example, (part of) the UL power control configurations for the target serving cell and the physical cell ID of the target serving cell may be in the same IE and in the same RRC message. For example, (part of) the UL power control configurations for the target serving cell and the additional PCI index of the target serving cell may be in the same IE and in the same RRC message. For example, (part of) the UL power control configurations for the target serving cell and the physical cell ID of the target serving cell may be in the different IEs but in the same RRC message. For example, (part of) the UL power control configurations for the target serving cell and the additional PCI index of the target serving cell may be in the different IEs but in the same RRC message.

In some implementations, (part of) the UL power control configurations for the target serving cell may be associated with the UL TCI state information (e.g., ul-TCI-StateList IE) of the target serving cell and/or associate with the UL TCI state configurations (e.g., TCI-UL-State IEs) of the target serving cell, e.g., especially when the UE is configured with ‘sepurute’ unified TCI state type by the network node. For example, (part of) the UL power control configurations for the target serving cell and the UL TCI state information of the target serving cell may be in the same IE and in the same RRC message. For example, (part of) the UL power control configurations for the target serving cell and the UL TCI state configurations of the target serving cell may be in the same IE and in the same RRC message. For example, (part of) the UL power control configurations for the target serving cell and the UL TCI state information of the target serving cell may be in the different IEs but in the same RRC message. For example, (part of) the UL power control configurations for the target serving cell and the UL TCI state configurations of the target serving cell may be in the different IEs but in the same RRC message.

In some implementations, (part of) the UL power control configurations for the target serving cell may be associated with the DLorJoint TCI state information (e.g., dl-orJoint-TCI-ToAddModList IE) of the target serving cell and/or associate with the DLorJoint TCI state configurations (e.g., DLorJoint-TCIState IEs) of the target serving cell, e.g., especially when the UE is configured with ‘joint’ unified TCI state type by the network node. For example, (part of) the UL power control configurations for the target serving cell and the DLorJoint TCI state information of the target serving cell may be in the same IE and in the same RRC message. For example, (part of) the UL power control configurations for the target serving cell and the DLorJoint TCI state configurations of the target serving cell may be in the same IE and in the same RRC message. For example, (part of) the UL power control configurations for the target serving cell and the DLorJoint TCI state information of the target serving cell may be in the different IEs but in the same RRC message. For example, (part of) the UL power control configurations for the target serving cell and the DLorJoint TCI state configurations of the target serving cell may be in the different IEs but in the same RRC message.

In some implementations, (part of) the UL power control configurations for the target serving cell may be associated with the UL TCI state information (e.g., ul-TCI-StateList IE) of the source serving cell and/or associate with the UL TCI state configurations (e.g., TCI-UL-State IEs) of the source serving cell, e.g., especially when the UE is configured with ‘separate’ unified TCI state type by the network node. In some implementations, the UE may (by default) apply and/or configure the UL TCI state information of the source serving cell for the UL TCI state information of the target serving cell. The UE may (by default) apply and/or configure the UL TCI state configurations of the source serving cell for the UL TCI state configurations of the target serving cell. There may be an implicit association between the UL TCI state information of the source serving cell and that of the target serving cell. There may be an implicit association between the UL TCI state configurations of the source serving cell and that of the target serving cell. For example, when the UL TCI state information (e.g., ul-TCI-StateList IE) of the source serving cell and/or the UL TCI state configurations (e.g., a list of UL TCI state configurations, TCI-UL-State IEs) of the source serving cell (only) includes one UL TCI state configuration, the UE may apply and/or configure the UL TCI state configuration for the target serving cell. Moreover, (part of) the UL power control configurations for the target serving cell may be associated with the UL TCI state configuration. For example, when the UL TCI state information (e.g., ul-TCI-StateList IE) of the source serving cell and/or the UL TCI state configurations (e.g., a list of UL TCI state configurations, TCI-UL-State IEs) of the source serving cell (only) includes two UL TCI state configurations, one for the source serving cell and another one for the target serving cell, the UE may apply and/or configure the UL TCI state configuration for the target serving cell. Moreover, (part of) the UL power control configurations for the target serving cell may be associated with the UL TCI state configuration for the target serving cell.

In some implementations, the UE may apply and/or configure the UL TCI state information of the source serving cell for the UL TCI state information of the target serving cell after receiving an explicit indication from the source serving cell or the target serving cell. In yet another implementation, the UE may apply and/or configure the UL TCI state configurations of the source serving cell for the UL TCI state configurations of the target serving cell after receiving an explicit indication from the source serving cell or the target serving cell. For example, (part of) the UL power control configurations for the target serving cell and the UL TCI state information of the source serving cell may be in the same IE and in the same RRC message. For example, (part of) the UL power control configurations for the target serving cell and the UL TCI state configurations of the source serving cell may be in the same IE and in the same RRC message. For example, (part of) the UL power control configurations for the target serving cell and the UL TCI state information of the source serving cell may be in the different IEs but in the same RRC message. For example, (part of) the UL power control configurations for the target serving cell and the UL TCI state configurations of the source serving cell may be in the different IEs but in the same RRC message.

In some implementations, (part of) the UL power control configurations for the target serving cell may be associated with the DLorJoint TCI state information (e.g., dl-orJoint-TCI-ToAddModList IE) of the source serving cell and/or associate with the DLorJoint TCI state configurations (e.g., DLorJoint-TCIState IEs) of the source serving cell, e.g., especially when the UE is configured with ‘joint’ unified TCI state type by the network node. In some implementations, the UE may (by default) apply and/or configure the DLorJoint TCI state information of the source serving cell for the UL TCI state information of the target serving cell. The UE may (by default) apply and/or configure the DLorJoint TCI state configurations of the source serving cell for the UL TCI state configurations of the target serving cell. There may be an implicit association between the DLorJoint TCI state information of the source serving cell and that of the target serving cell. There may be an implicit association between the DLorJoint TCI state configurations of the source serving cell and that of the target serving cell. For example, when the DLorJoint TCI state information (e.g., dl-orJoint-TCI-ToAddModList IE) of the source serving cell and/or DLorJoint TCI state configurations (e.g., a list of DLorJoint TCI state configurations) of the source serving cell (only) includes one DLorJoint TCI state configuration, the UE may apply and/or configure the DLorJoint TCI state configuration for the target serving cell. Moreover, (part of) the UL power control configurations for the target serving cell may be associated with the DLorJoint TCI state configuration. For example, when the DLorJoint TCI state information (e.g., dl-orJoint-TCI-ToAddModList IE) of the source serving cell and/or DLorJoint TCI state configurations (e.g., a list of DLorJoint TCI state configurations) of the source serving cell (only) includes two DLorJoint TCI state configurations, one for the source serving cell and another one for the target serving cell, the UE may apply and/or configure the DLorJoint TCI state configuration for the target serving cell. Moreover, (part of) the UL power control configurations for the target serving cell may be associated with the DLorJoint TCI state configuration for the target serving cell.

In some implementations, the UE may apply and/or configure the DLorJoint TCI state information of the source serving cell for the DLorJoint TCI state information of the target serving cell after receiving an explicit indication from the source serving cell or the target serving cell. In yet another implementation, the UE may apply and/or configure the DLorJoint TCI state configurations of the source serving cell for the DLorJoint TCI state configurations of the target serving cell after receiving an explicit indication from the source serving cell or the target serving cell. For example, (part of) the UL power control configurations for the target serving cell and the DLorJoint TCI state information of the source serving cell may be in the same IE and in the same RRC message. For example, (part of) the UL power control configurations for the target serving cell and the DLorJoint TCI state configurations of the source serving cell may be in the same IE and in the same RRC message. For example, (part of) the UL power control configurations for the target serving cell and the DLorJoint TCI state information of the source serving cell may be in the different IEs but in the same RRC message. For example, (part of) the UL power control configurations for the target serving cell and the DLorJoint TCI state configurations of the source serving cell may be in the different IEs but in the same RRC message.

In some implementations, the UE may (by default) apply and/or configure (part of) the UL power control configurations for the source serving cell for (part of) the UL power control configurations for the target serving cell, e.g., implicitly. For example, upon/after the UE receives (part of) the UL power control configurations for the source serving cell, the UE may apply the received (part of) the UL power control configurations for the source serving cell, for the target serving cell. For example, if (part of) the UL power control configurations for the source serving cell (only) includes one UL power control configuration, the UE may apply this UL power control configuration for the target serving cell. For example, if (part of) the UL power control configurations for the source serving cell (only) includes two UL power control configurations, e.g., one of the two UL power control configurations is used for the source serving cell, another one of the two UL power control configurations is used for the target serving cell, the UE may apply the another one of the two UL power control configurations used for the target serving cell, for the target serving cell.

In some implementations, the UE may apply and/or configure (part of) the UL power control configurations for the source serving cell for (part of) the UL power control configurations for the target serving cell, e.g., explicitly, after the UE receives an explicit indication from the source serving cell or the target serving cell.

In some implementations, the UE may apply and/or configure (part of) the UL power control configurations for the source serving cell for (part of) the UL power control configurations for the target serving cell, e.g., explicitly, after the UE receive (part of) the UL power control configurations from the source serving cell.

In some implementations, a list of power control configurations configured by an RRC message from the source serving cell or target serving cell may include both the power control configurations associated with the source serving cell and the power control configurations associated with the target serving cell. The source serving cell may be identified by the PCI of the serving cell, serving cell ID and so on. The target serving cell may be identified by a PCI different from the PCI of the serving cell, a PCI index and so on.

In some implementations, (part of) the UL power control configurations for the target serving cell may be BWP-specific to the UE. For example, (part of) the UL power control configurations for the target serving cell may be associated with an (UL) BWP ID of the target serving cell. The UE may apply and/or configure (part of) the UL power control configurations for the target serving cell for the corresponding UL BWP indicated by the (UL) BWP ID. The (UL) BWP ID of the target serving cell and (part of) the UL power control configurations for the target serving cell may be in the same IE and in the same message. The (UL) BWP ID of the target serving cell and (part of) the UL power control configurations for the target serving cell may be in the different IEs but in the same message. (Part of) the UL power control configurations for the target serving cell may be included in an UL dedicated BWP IE in the RRC message. The UE may apply and/or configure (part of) the UL power control configurations for the target serving cell for the corresponding UL BWP indicated by the UL dedicated BWP IE.

In some implementations, (part of) the UL power control configurations for the target serving cell may be cell-specific to the UE. For example, (part of) the UL power control configurations for the target serving cell may be associated with a cell ID (or a cell index) of the target serving cell or associate with a PCI (or an additional PCI index) for the target serving cell. The UE may apply and/or configure (part of) the UL power control configurations for the target serving cell for the corresponding target serving cell indicated by the cell ID (or the cell index) of the target serving cell or the PCI (or the additional PCI index) for the target serving cell.

In some implementations, if the UE has received, applied and/or configured (part of) the BWP-specific UL power control configurations for the target serving cell, the UE may not expect to receive, apply and/or configure (part of) the cell-specific UL power control configurations for the target serving cell.

In some implementations, if the UE has received, applied and/or configured (part of) the cell-specific UL power control configurations for the target serving cell, once the UE receives (part of) the BWP-specific UL power control configurations for the target serving cell, the UE may apply the received (part of) BWP-specific UL power control configurations for the target serving cell and/or release (part of) the cell-specific UL power control configurations for the target serving cell. In some implementations, if the UE has received, applied and/or configured (part of) the cell-specific UL power control configurations for the target serving cell, once the UE received (part of) the BWP-specific UL power control configurations for the target serving cell, the UE may replace the received (part of) BWP-specific UL power control configurations for the target serving cell with (part of) the cell-specific UL power control configurations for the target serving cell.

In some implementations, if the UE has received, applied and/or configured (part of) the cell-specific UL power control configurations for the target serving cell, once the UE receives another (part of) the cell-specific UL power control configurations for the target serving cell, the UE may apply and/or configure the newly received (part of) cell-specific UL power control configurations for the target serving cell and/or release previously received, applied and/or configured (part of) the cell-specific UL power control configurations for the target serving cell.

In some implementations, if the UE has received, applied and/or configured (part of) the BWP-specific UL power control configurations for the target serving cell, once the UE receives (part of) the BWP-specific UL power control configurations for the target serving cell, the UE may apply and/or configure the newly received (part of) BWP-specific UL power control configurations for the target serving cell and/or release previously received, applied and/or configured (part of) the BWP-specific UL power control configurations for the target serving cell.

In some implementations, if the UE has received, applied and/or configured (part of) the BWP-specific UL power control configurations for the target serving cell, once the UE receives (part of) the cell-specific UL power control configurations for the target serving cell, the UE may ignore the newly received (part of) cell-specific UL power control configurations for the target serving cell.

In some implementations, after the UE receives the MAC CE for the UL power control update/activation for the target serving cell, the UE may indicate, to the lower layer of the MAC layer of the UE, the information regarding the MAC CE for the UL power control update for the target serving cell.

In some implementations, if the MAC entity of the UE receives the MAC CE for the UL power control update for the target serving cell on the source serving cell, the MAC entity of the UE may indicate, to the lower layers of the UE (e.g., the PHY layers of the UE), the information regarding the MAC CE for the UL power control update for the target serving cell. Specifically, this implementation is applied by the UE when the UE handles the source serving cell and the target serving cell by using the same MAC entity and the same PHY layer. Specifically, this implementation is applied by the UE when the UE is operated/configured in the intra-CU intra-DU inter-cell scenario.

In some implementations, if the MAC entity of the UE receives the MAC CE for the UL power control update for the target serving cell on the source serving cell, the MAC entity of the UE may indicate, to the upper layers of the UE (e.g., the RRC layer of the UE), that the UL power control update for the target serving cell is required/triggered. Specifically, this implementation is applied by the UE when the UE handles the source serving cell and the target serving cell by using different MAC entities and different PHY layers. Specifically, this implementation is applied by the UE when the UE is operated/configured in the intra-CU inter-DU inter-cell scenario.

In some implementations, if the MAC entity of the UE receives the MAC CE for the UL power control update for the target serving cell on the source serving cell, the MAC entity of the UE may determine the MAC CE content. If the UE determines that the MAC CE is applied for the target serving cell, e.g., by determining the serving cell identity field in the MAC CE, the MAC entity of the UE may indicate, to the upper layers of the UE (e.g., the RRC layer of the UE), that the UL power control update for the target serving cell is required/triggered. Specifically, this implementation is applied by the UE when the UE handles the source serving cell and the target serving cell by using different MAC entities and different PHY layers. Specifically, this implementation is applied by the UE when the UE is operated/configured in the intra-CU inter-DU inter-cell scenario.

In some implementations, upon/after the upper layers of the UE receives the indication, the upper layers of the UE may request the network to transmit the RRC message including the UL power control configuration and/or the MAC CE for the UL power control update for the target serving cell. Specifically, the UE may request the target serving cell to provide the MAC CE for the UL power control update for the target serving cell.

In some implementations, if the UE determines that the MAC CE is applied for the target serving cell, e.g., by determining the serving cell identity field in the MAC CE, the MAC entity of the UE may provide, to the upper layers of the UE (e.g., the RRC layer of the UE), the necessary information in the MAC CE for the UL power control update for the target serving cell.

In some implementations, if the MAC entity of the UE receives the MAC CE for the UL power control update for the target serving cell on the target serving cell, the MAC entity of the UE may indicate, to the lower layers of the UE (e.g., the PHY layers of the UE), the information regarding the MAC CE for the UL power control update for the target serving cell. Specifically, this implementation is applied by the UE when the UE handles the source serving cell and the target serving cell by using the same MAC entity and the same PHY layer. Specifically, this implementation is applied by the UE when the UE is operated/configured in the intra-CU intra-DU inter-cell scenario. Specifically, this implementation is applied by the UE when the UE handles the source serving cell and the target serving cell by using different MAC entities and different PHY layers. Specifically, this implementation is applied by the UE when the UE is operated/configured in the intra-CU inter-DU inter-cell scenario.

In some implementations, the MAC CE for the UL power control update for the target serving cell may be identified by a MAC subheader with eLCID (extended Logical Channel IDentity). It is noted that an eLCID field identifies the logical channel instance of the corresponding MAC SDU or the type of the corresponding MAC CE for the DL-SCH and UL-SCH respectively. The size of the eLCID field is either 8 bits or 16 bits, but not limited to.

In some implementations, the MAC CE for the UL power control update for the target serving cell may include the fields such as (but not limited to) a serving cell index (or a serving cell ID), an additional PCI index, a BWP ID, UL TCI state identity identifying the corresponding UL TCI state, DLorJoint TCI state identity identifying the corresponding DLorJoint TCI state, UL power control identity identifying the corresponding UL power control configuration, a control bit to indicate whether single or two UL power control configurations are updated for the following TCI state, an indication to indicate whether UL TCI state or DLorJoint TCI state is applied, and reserved bits.

For example, the length of a serving cell index (or a serving cell ID) field may be several bits (e.g., 2, 3, 4, or 5 bits). The serving cell index (or the serving cell ID) field may indicate the serving cell index (or the serving cell ID) of the target serving cell associated with this MAC CE. The fields in this MAC CE may be applied for the target serving cell associated with this MAC CE. If this field is absent, the fields in this MAC CE may be applied for the serving cell from which the UE receives this MAC CE. It is noted that the serving cell index (or the serving cell ID) field may correspond to the serving cell ID or the serving cell index that is associated with the UL power control configurations received in the RRC message.

For example, the length of an additional PCI index field may be several bits (e.g., 2, 3, 4, or 5 bits). The additional PCI index may indicate the target serving cell associated with this MAC CE. The fields in this MAC CE may be applied for the target serving cell associated with this MAC CE. In some implementations, this additional PCI index field is present when the serving cell ID (or the serving cell index) does not indicate the target serving cell; otherwise, this additional PCI index field is absent. In some implementations, this additional PCI index field is present when the serving cell ID (or the serving cell index) indicates the source serving cell; otherwise, this additional PCI index field is absent. In some implementations, this additional PCI index field is present when the UE receives the additional PCI indexes associated with the UL power control configurations in the RRC message; otherwise, this additional PCI index field is absent. In some implementations, if this additional PCI index field is absent and the serving cell ID (or serving cell index) field is absent, the fields in this MAC CE may be applied for the serving cell from which the UE receives this MAC CE. It is noted that the additional PCI index field may correspond to the additional PCI index that is associated with the UL power control configurations received in the RRC message.

For example, the length of the BWP ID field may be 2 bits, but not limited to. The BWP ID may indicate the corresponding BWP that applies the update of the UL power control configurations. If this field is absent, the update of the UL power control configurations may be applied for the cell indicated by the serving cell ID (or serving cell index) field and/or the additional PCI index field. It is noted that the BWP ID field may correspond to the (UL) BWP ID or the UL dedicated BWP IE that is associated with the UL power control configurations received in the RRC message.

For example, the UL TCI state identity field may indicate the UL TCI state of the target serving cell to update the UL power control configurations indicated in this MAC CE. The UL TCI state identity field may be associated with one or two UL power control configurations indicated in this MAC CE. It is noted that the UL TCI state identity may be one of UL TCI state identities that the UE receives in the RRC message including the UL power control configurations, and/or that the UE applies and/or configures based on the RRC message including the UL power control configurations. It is noted that the UL TCI state identity field may correspond to more than one UL TCI states for a serving cell and the more than one UL power control configurations may correspond to the more than one UL TCI states.

For example, the DLorJoint TCI state identity field may indicate the UL TCI state of the target serving cell to update the UL power control configurations indicated in this MAC CE. The DLorJoint TCI state identity field may be associated with one or two UL power control configurations indicated in this MAC CE. It is noted that the DLorJoint TCI state identity may be one of DLorJoint TCI state identities that the UE receives in the RRC message including the UL power control configurations, and/or that the UE applies and/or configures based on the RRC message including the UL power control configurations. It is noted that the DLorJoint TCI state identity field may correspond to more than one DLorJoint TCI states for a serving cell.

For example, the UL power control identity field may indicate the UL power control configuration to be updated for the corresponding serving cell, BWP and/or TCI state indicated in this MAC CE. It is noted that the UL power control identity in the UL power control identity field may be one of the UL power control identities that the UE receives in the RRC message including the UL power control configurations and/or that the UE applies and/or configures based on the RRC message including the UL power control configurations. In some implementations, single UL power control identity field is associated with the corresponding UL TCI state field. In some implementations, two UL power control identity fields are associated with the corresponding UL TCI state field. In some implementations, the UE may determine whether single or two UL power control identity fields are associated with the corresponding UL TCI state field based on a control bit field. In some implementations, single UL power control identity field is associated with the corresponding DLorJoint TCI state field. In some implementations, two UL power control identity fields are associated with the corresponding DLorJoint TCI state field. In some implementations, the UE may determine whether single or two UL power control identity fields are associated with the corresponding DLorJoint TCI state field based on a control bit field. In some implementations, the UL power control identity field is mandatorily present in this MAC CE. In some implementations, the UL power control identity field may correspond to an UL power control configuration list index.

For example, a control bit field may indicate whether single or two UL power controls configurations are updated for the corresponding TCI state. The corresponding TCI state may be indicated by UL TCI state identity field or by DLorJoint TCI state identity field. In some implementations, if the control bit field is ‘1,’ the control bit field may indicate two UL power control configuration is updated for the corresponding TCI state. For example, the second UL power control identity field exists. In some implementations, if the control bit field is ‘0’ or absent, the control bit field may indicate single UL power control configuration is updated for the corresponding TCI state. For example, the second UL power control identity field is absent.

For example, an indication field may indicate whether UL TCI state identity or DLorJoint TCI state identity would be applied for the UL TCI state field (e.g., UL TCI state identity field, DLorJoint TCI state identity field) to indicate the UL TCI in this MAC CE. In some implementations, if the indication is ‘1,’ the indication may indicate UL TCI state identity field is applied for indicating the UL TCI state in this MAC CE. In some implementations, if the indication is ‘1,’ the indication may indicate UL TCI state identity field is applied for indicating the UL TCI state associated with the corresponding UL power control identity field in this MAC CE. In some implementations, if the indication is ‘0’ or absent, the indication may indicate DLorJoint TCI state identity field is applied for indicating the UL TCI state in this MAC CE. In some implementations, if the indication is ‘0’ or absent, the indication may indicate DLorJoint TCI state identity field is applied for indicating the UL TCI state associated with the corresponding UL power control identity field in this MAC CE. Alternatively, in some implementations, if the indication is ‘1,’ the indication may indicate DLorJoint TCI state identity field is applied for indicating the UL TCI state in this MAC CE. In some implementations, if the indication is ‘1,’ the indication may indicate DLorJoint TCI state identity field is applied for indicating the UL TCI state associated with the corresponding UL power control identity field in this MAC CE. In some implementations, if the indication is ‘0’ or absent, the indication may indicate UL TCI state identity field is applied for indicating the UL TCI state in this MAC CE. In some implementations, if the indication is ‘0’ or absent, the indication may indicate UL TCI state identity field is applied for indicating the UL TCI state associated with the corresponding UL power control identity field in this MAC CE. There may be several reserved bit fields in this MAC CE.

Upon/after the UE receives this MAC CE, the UE may determine the UL power control configurations to be updated for the corresponding serving cell (especially the target serving cell), the corresponding BWP, and/or the corresponding UL TCI states based on the fields in this MAC CE and/or from which serving cell the UE receives this MAC CE.

As described in action 102 of FIG. 1, the UE may apply (e.g., select and/or use) a first TCI state and a first UL power control configuration, which are associated with the first TRP, to perform a first UL transmission toward the first TRP. In some implementations, the UE may perform the first UL transmission (e.g., including PUCCH transmission, PUSCH transmission, SRS transmission) toward the first TRP (e.g., associated with the source serving cell) by applying a first UL power control configuration. The UE may perform the first UL transmission (e.g., including PUCCH transmission, PUSCH transmission, SRS transmission) by using the first TCI state associated with the source serving cell by applying the first UL power control configuration, where the first TCI state may be an UL TCI state or a joint TCI state.

The UL power control configuration for the PUCCH transmission may be included in the first UL power control configuration. Specifically, if the UE performs the PUCCH transmission, the UE may apply the UL power control configuration for the PUCCH transmission in the first UL power control configuration. Additionally or alternatively, the UL power control configuration for the PUSCH transmission may be included in the first UL power control configuration. Specifically, if the UE performs the PUSCH transmission, the UE may apply the UL power control configuration for the PUSCH transmission in the first UL power control configuration. Additionally or alternatively, the UL power control configuration for the SRS transmission may be included in the first UL power control configuration. Specifically, if the UE performs the SRS transmission, the UE may apply the UL power control configuration for the SRS transmission in the first UL power control configuration. Additionally or alternatively, the first UL power control configuration may be indicated by the UL power control identity field in an MAC CE.

The first (UL) TCI state may be indicated in the UL TCI state identity field or the DLorJoint TCI state identity field in an MAC CE. The first (UL) TCI state may be associated with the first UL power control configuration.

The first UL power control configuration may be indicated by a first power control configuration (e.g., a power control configuration corresponding to the source serving cell) in the list of power control configurations configured by an RRC message if the list of power control parameter configurations includes only one power control configuration corresponding to the source serving cell. The first UL power control configuration may be indicated by a DCI field or a specific DCI format scheduling the corresponding UL transmissions.

On the other hand, as described in action 104 of FIG. 1, the UE may apply a second TCI state and a second UL power control configuration, which are associated with the second TRP, to perform a second UL transmission toward the second TRP. In some implementations, the UE may perform the second UL transmission (e.g., including PUCCH transmission, PUSCH transmission, SRS transmission) toward the second TRP (e.g., associated with the target serving cell) by applying a second UL power control configuration. For example, the UE may perform the second UL transmission (e.g., including PUCCH transmission, PUSCH transmission, SRS transmission) by using the second TCI state associated with the target serving cell by applying a second UL power control configuration, where the second TCI state may be an UL TCI state or a joint TCI state.

The UL power control configuration for the PUCCH transmission may be included in the second UL power control configuration. Specifically, if the UE performs the PUCCH transmission, the UE may apply the UL power control configuration for the PUCCH transmission in the second UL power control configuration. Additionally or alternatively, the UL power control configuration for the PUSCH transmission may be included in the second UL power control configuration. Specifically, if the UE performs the PUSCH transmission, the UE may apply the UL power control configuration for the PUSCH transmission in the second UL power control configuration. Additionally or alternatively, the UL power control configuration for the SRS transmission may be included in the second UL power control configuration. Specifically, if the UE performs the SRS transmission, the UE may apply the UL power control configuration for the SRS transmission in the second UL power control configuration.

In some implementations, the second UL power control configuration may be indicated by the UL power control identity field in an MAC CE. The second (UL) TCI state may be indicated in the UL TCI state identity field or the DLorJoint TCI state identity field in an MAC CE. The second (UL) TCI state may be associated with the second UL power control configuration.

In some implementations, the first UL power control configuration may be indicated by a second power control configuration (e.g., a power control configuration corresponding to the target serving cell) in the list of power control configurations configured by an RRC message if the list of power control parameter configurations includes only one power control configuration corresponding to the target serving cell. In some implementations, the first UL power control configuration may be indicated by a DCI field or a specific DCI format scheduling the corresponding UL transmissions.

In some implementations, the first (UL) TCI state and the second (UL) TCI state may be the same. The UE may apply the first (UL) TCI state indicated in the MAC CE for the source serving cell, for the target serving cell. Alternatively, the UE may apply the second (UL) TCI state indicated in the MAC CE for the target serving cell, for the source serving cell.

In some implementations, the first UL power control configuration and the second UL power control configuration may be the same. The UE may apply the first UL power control configuration indicated in the MAC CE for the source serving cell, for the target serving cell. Alternatively, the UE may apply the second UL power control configuration indicated in the MAC CE for the target serving cell, for the source serving cell.

In some implementations, the UE may perform the first UL transmission toward the first TRP (e.g., associated with the source serving cell) and perform the second UL transmission toward the second TRP (e.g., associated with the target serving cell) simultaneously. In some implementations, the UE may perform the UL transmission by using the first (UL) TCI state associated with the source serving cell and perform the UL transmission by using the second (UL) TCI state associated with the target serving cell, simultaneously.

The following content provides supplementary explanations for the various implementations presented in the present disclosure.

The terms network (NW), cell, camped cell, serving cell, BS, gNB, eNB, and ng-eNB may be used interchangeably. Some of these items may or may not refer to the same network entity.

The RAT may be (but not limited to) NR, LTE, E-UTRA connected to 5GC, LTE connected to 5GC, E-UTRA connected to EPC, and LTE connected to EPC. The proposed mechanism may be applied for UEs in public networks, or in private network (e.g., NPN (non-public network, SNPN (standalone NPN), PNI-NPN (public network integrated NPN)).

The proposed mechanism may be used for licensed frequency and/or unlicensed frequency.

System information (SI) may refer to MIB, SIB1, and other SI. Minimum SI may include MIB and SIB1. Other SI may refer to SIB3, SIB4, SIB5, and other SIB(s).

Dedicated signaling may refer to (but not limited to) RRC message(s). For example, RRC (Connection) Setup Request message, RRC (Connection) Setup message, RRC (Connection) Setup Complete message, RRC (Connection) Reconfiguration message, RRC Connection Reconfiguration message including the mobility control information, RRC Connection Reconfiguration message without the mobility control information inside, RRC Reconfiguration message including the configuration with sync, RRC Reconfiguration message without the configuration with sync inside, RRC (Connection) Reconfiguration Complete message, RRC (Connection) Resume Request message, RRC (Connection) Resume message, RRC (Connection) Resume Complete message, RRC (Connection) Reestablishment Request message, RRC (Connection) Reestablishment message, RRC (Connection) Reestablishment Complete message, RRC (Connection) Reject message, RRC (Connection) Release message, RRC System Information Request message, UE Assistance Information message, UE Capability Enquiry message, and UE Capability Information message.

The RRC_CONNECTED UE, RRC_INACTIVE UE, and RRC_IDLE UE may apply the proposed implementations.

An RRC_CONNECTED UE may be configured with an active BWP with common search space configured to monitor system information or paging.

The RRC_CONNECTED UE configured with ICBM may be configured with an active BWP on the serving cell with common search space configured to monitor system information or paging from the serving cell.

The RRC_CONNECTED UE configured with ICBM may be configured with an active BWP on the target serving cell with common search space configured to monitor system information or paging from the target serving cell.

The UE may be served by a cell, e.g., serving cell. The serving cell may serve (but not limited to) an RRC_CONNECTED UE. The serving cell may be (but not limited to) a suitable cell.

The UE may camp on a cell, e.g., camped cell. The camped cell may be a suitable cell or an acceptable cell.

A suitable cell is a cell on which a UE may camp. The UE may consider a cell as suitable if the following conditions are fulfilled: (1) The cell is part of either the selected PLMN or the registered PLMN or PLMN of the Equivalent PLMN list, and (2) The cell criteria of the cell are fulfilled. Furthermore, according to the latest information provided by NAS, the suitable cell is not barred. The suitable cell is part of at least one TA that is not part of the list of “Forbidden Tracking Areas”, which belongs to a PLMN that fulfils the condition (1).

The target serving cell may be a suitable cell.

For an intra-cell case, the target serving cell mentioned in the implementations may be regarded as a second TRP associated with the (source) serving cell.

A DL BWP may refer to an initial (DL) BWP, a default BWP, an active (DL) BWP.

PCell (Primary Cell): The MCG cell, operating on the primary frequency, in which the UE either performs the initial connection establishment procedure or initiates the connection re-establishment procedure.

PSCell (Primary SCG Cell): For dual connectivity operation, the SCG cell in which the UE performs random access when performing the Reconfiguration with Sync procedure.

Serving Cell: For a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells.

Secondary Cell: For a UE configured with CA, a cell providing additional radio resources on top of Special Cell.

Special Cell (SpCell): For Dual Connectivity operation the term Special Cell refers to the PCell of the MCG or the PSCell of the SCG, otherwise the term Special Cell refers to the PCell.

Master Cell Group: in MR-DC, a group of serving cells associated with the Master Node, comprising of the SpCell (PCell) and optionally one or more SCells.

Master node: in MR-DC, the radio access node that provides the control plane connection to the core network. It may be a Master eNB (in EN-DC), a Master ng-eNB (in NGEN-DC) or a Master gNB (in NR-DC and NE-DC).

Secondary Cell Group: in MR-DC, a group of serving cells associated with the Secondary Node, comprising of the SpCell (PSCell) and optionally one or more SCells.

Secondary node: in MR-DC, the radio access node, with no control plane connection to the core network, providing additional resources to the UE. It may be an en-gNB (in EN-DC), a Secondary ng-eNB (in NE-DC) or a Secondary gNB (in NR-DC and NGEN-DC).

The terms “serving cell”, “TRP associated with the PCI of the serving cell”, “TRP associated with the serving cell”, “TRP of a serving cell” and “TRP of the serving cell” may be used interchangeably.

In the present disclosure, the terms “target cell”, “target serving cell”, “TRP associated with a PCI different from the PCI of the serving cell”, and “TRP associated with the target cell” may be used interchangeably. A target serving cell may be identified by a PCI or a PCI index. A UE may be configured with at most 1, 4, 8, or 32 PCI indices. Each PCI index may identify a target serving cell of the UE.

The serving cell in the implementations may be a PCell, SCell or PSCell.

The target serving cell in the implementations may be a PCell, SCell or PSCell.

An inter-cell to the serving cell of the UE may be a neighboring cell, a cell other than the serving cell or a cell with PCI different from the PCI of the serving cell. If the UE can perform the inter-cell beam management, the UE may be in coverage of the inter-cell.

The term “MAC layer” and the term “MAC entity” may be used interchangeably.

The fact that the UE is configured with the unified TCI framework (e.g., the unified TCI configuration) may be equivalent to the fact that the UE is configured with unified TCI state operation.

SpCellConfig: Serving-cell-specific MAC and PHY parameters for a SpCell. Parameters for the SpCell of this cell group (PCell of MCG or PSCell of SCG). SpCellConfig is included in CellGroupConfig. SpCellConfig may include ServingCellConfig.

SCellConfig: SCellConfig is included in CellGroupConfig. SCellConfig may include ServingCellConfig.

ServingCellConfig: The IE ServingCellConfig is used to configure (add or modify) the UE with a serving cell, which may be the SpCell or an SCell of an MCG or SCG. The parameters herein are mostly UE-specific but partly also cell-specific (e.g., in additionally configured bandwidth parts). Reconfiguration between a PUCCH and PUCCHless SCell is only supported using an SCell release and add.

CellGroupConfig: Configuration of one Cell-Group. The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

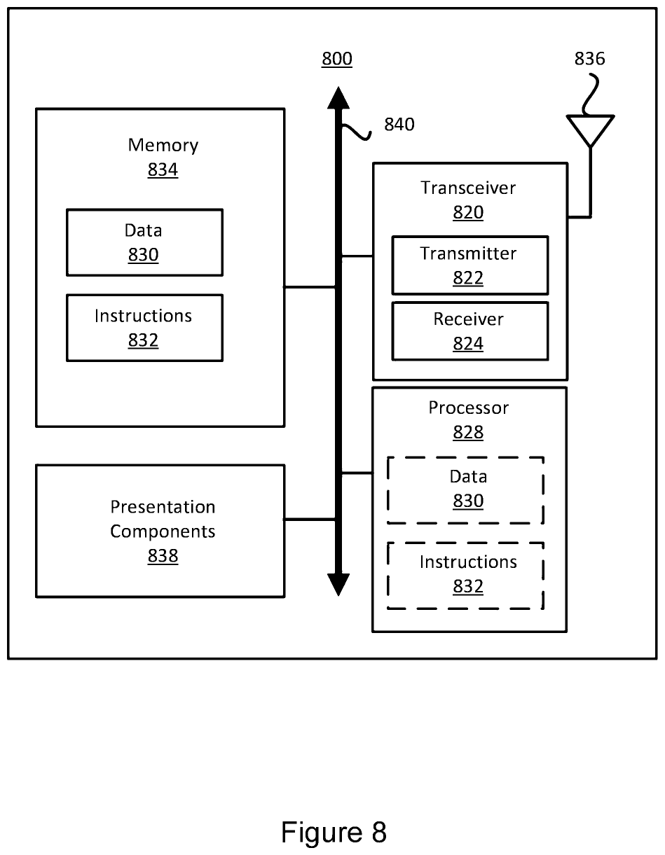

FIG. 8 is a block diagram illustrating a node 800 for wireless communication, according to an example implementation of the present disclosure. As illustrated in FIG. 8, a node 800 may include a transceiver 820, a processor 828, a memory 834, one or more presentation components 838, and at least one antenna 836. The node 800 may also include a radio frequency (RF) spectrum band module, a BS communications module, a network communications module, and a system communications management module, Input/Output (I/O) ports, I/O components, and a power supply (not illustrated in FIG. 8).

Each of the components may directly or indirectly communicate with each other over one or more buses 840. The node 800 may be a UE or a BS that performs various functions disclosed with reference to FIGS. 1 through 7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including, but not limited to, usable, non-usable and flexibly usable subframes and slot formats. The transceiver 820 may be configured to receive data and control channels.

The node 800 may include a variety of computer-readable media. Computer-readable media may be any available media that may be accessed by the node 800 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 834 may include computer-storage media in the form of volatile and/or non-volatile memory. The memory 834 may be removable, non-removable, or a combination thereof. Example memory may include solid-state memory, hard drives, optical-disc drives, etc. As illustrated in FIG. 8, the memory 834 may store a computer-readable and/or computer-executable instructions 832 (e.g., software codes or programs) that are configured to, when executed, cause the processor 828 to perform various functions disclosed herein, for example, with reference to FIGS. 1 through 7. Alternatively, the instructions 832 may not be directly executable by the processor 828 but may be configured to cause the node 800 (e.g., when compiled and executed) to perform various functions disclosed herein.

The processor 828 (e.g., having processing circuitry) may include an intelligent hardware device, e.g., a Central Processing Unit (CPU), a microcontroller, an ASIC, etc. The processor 828 may include memory. The processor 828 may process the data 830 and the instructions 832 received from the memory 838, and information transmitted and received via the transceiver 820, the baseband communications module, and/or the network communications module. The processor 828 may also process information to send to the transceiver 820 for transmission via the antenna 836 to the network communications module for transmission to a Core Network (CN).

One or more presentation components 838 may present data indications to a person or another device. Examples of presentation components 838 may include a display device, a speaker, a printing component, a vibrating component, etc.

In view of the present disclosure, various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are considered in all respects as illustrative and not restrictive. It should also be understood that the present disclosure is not limited to the specific implementations disclosed. Still, many rearrangements, modifications, and substitutions are possible without departing from the scope of the present disclosure.

1. A method performed by a User Equipment (UE) for performing multi-Transmission and Reception Point (mTRP) operations to communicate with a plurality of Transmission and Reception Points (TRPs) comprising a first TRP and a second TRP, the method comprising:
applying a first Transmission Configuration Indication (TCI) state and a first Uplink (UL) power control configuration, which are associated with the first TRP, to perform a first UL transmission toward the first TRP; and
applying a second TCI state and a second UL power control configuration, which are associated with the second TRP, to perform a second UL transmission toward the second TRP.

2-7. (canceled)

8. A User Equipment (UE) for performing multi-Transmission and Reception Point (mTRP) operations to communicate with a plurality of Transmission and Reception Points (TRPs) comprising a first TRP and a second TRP, the UE comprising:
at least one processor; and
at least one non-transitory computer-readable medium coupled to the at least one processor and storing one or more computer-executable instructions that, when executed by the at least one processor, cause the UE to:
apply a first Transmission Configuration Indication (TCI) state and a first Uplink (UL) power control configuration, which are associated with the first TRP, to perform a first UL transmission toward the first TRP; and
apply a second TCI state and a second UL power control configuration, which are associated with the second TRP, to perform a second UL transmission toward the second TRP.

9. The UE of claim 8, wherein the one or more computer-executable instructions, when executed by the at least one processor, further cause the UE to:
receive a Radio Resource Control (RRC) message from the first TRP, the RRC message comprising a set of UL power control configurations associated with the second TRP, wherein the set of UL power control configurations comprises the second UL power control configuration;
receive a Medium Access Control (MAC) Control Element (CE) from one of the first TRP and the second TRP, the MAC CE indicating to the UE to apply the second UL power control configuration, among the set of UL power control configurations, to perform the second UL transmission; and
indicate to a lower layer of a MAC layer of the UE information regarding the MAC CE.

10. The UE of claim 9, wherein the MAC CE comprises at least one of:
a serving cell Identity (ID) of a serving cell associated with the second TRP,
a power control configuration ID of the second UL power control configuration, or
a TCI state ID of the second TCI state.

11. The UE of claim 8, wherein the one or more computer-executable instructions, when executed by the at least one processor, further cause the UE to:
receive first unified TCI state type indication of a type of the first TCI state; and
receive second unified TCI state type indication of a type of the second TCI state,
wherein each of the type of the first TCI state and the type of the second TCI state is one of an UL TCI state and a joint TCI state.

12. The UE of claim 8, wherein the one or more computer-executable instructions, when executed by the at least one processor, further cause the UE to:
determine a first UL transmission power for the first UL transmission based on the first UL power control configuration;
determine a second UL transmission power for the second UL transmission based on the second UL power control configuration;
use the first UL transmission power to transmit a first set of UL resources toward the first TRP; and
use the second UL transmission power to transmit a second set of UL resources toward the second TRP, wherein:
the first set of UL resources comprises a first Physical Uplink Control Channel (PUCCH), a first Physical Uplink Shared Channel (PUSCH), and a first Sounding Reference Signal (SRS), and
the second set of UL resources comprises a second PUCCH, a second PUSCH, and a second SRS.

13. The UE of claim 8, wherein:
the first UL power control configuration is associated with at least one of:
the first TCI state,
a first TCI state Identity (ID) of the first TCI state,
a first panel ID associated with the first TRP,
a first cell ID associated with the first TRP,
a first search space ID associated with the first TRP,
a first Control Resource Set (CORESET) ID associated with the first TRP,
a first CORESET pool index associated with the first TRP, or
a first TRP-specific ID associated with the first TRP, and
the second UL power control configuration is associated with at least one of:
the second TCI state,
a second TCI state ID of the second TCI state,
a second panel ID associated with the second TRP,
a second cell ID associated with the second TRP,
a second search space ID associated with the second TRP,
a second CORESET ID associated with the second TRP,
a second CORESET pool index associated with the second TRP, or
a second TRP-specific ID associated with the second TRP.

14. The UE of claim 8, wherein:
the first UL power control configuration comprises at least one of:
a first UL power control ID associated with the first TRP,
a first P0 alpha set configuration for a first Physical Uplink Control Channel (PUCCH) associated with the first TRP,
a second P0 alpha set configuration for a first Physical Uplink Shared Channel (PUSCH) associated with the first TRP, or
a third P0 alpha set configuration for a first Sounding Reference Signal (SRS) associated with the first TRP, and
the second UL power control configuration comprises at least one of:
a second UL power control ID associated with the second TRP,
a fourth P0 alpha set configuration for a second PUCCH associated with the second TRP,
a fifth P0 alpha set configuration for a second PUSCH associated with the second TRP, or
a sixth P0 alpha set configuration for a second SRS associated with the second TRP.

15. A Base Station (BS) for performing multi-Transmission and Reception Point (mTRP) operations to communicate with a User Equipment (UE) via a plurality of Transmission and Reception Points (TRPs) comprising a first TRP and a second TRP, the BS comprising:
at least one processor; and
at least one non-transitory computer-readable medium coupled to the at least one processor and storing one or more computer-executable instructions that, when executed by the at least one processor, cause the BS to:
configure the UE with a first Transmission Configuration Indication (TCI) state and a first Uplink (UL) power control configuration, which are associated with the first TRP, enabling the UE to perform a first UL transmission toward the first TRP based on the first TCI state and the first UL power control configuration; and
configure the UE with a second TCI state and a second UL power control configuration, which are associated with the second TRP, enabling the UE to perform a second UL transmission toward the second TRP based on the second TCI state and the second UL power control configuration.

16. The BS of claim 15, wherein the one or more computer-executable instructions, when executed by the at least one processor, further cause the BS to:
transmit, via the first TRP, a Radio Resource Control (RRC) message comprising a set of UL power control configurations associated with the second TRP to the UE, the set of UL power control configurations comprising the second UL power control configuration; and
transmit, via one of the first TRP and the second TRP, a Medium Access Control (MAC) Control Element (CE) to the UE, the MAC CE indicating to the UE to apply the second UL power control configuration among the set of UL power control configurations to perform the second UL transmission.

17. The BS of claim 16, wherein the MAC CE comprises at least one of:
a serving cell Identity (ID) of a serving cell associated with the second TRP,
a power control configuration ID of the second UL power control configuration, or
a TCI state ID of the second TCI state.

18. The BS of claim 15, wherein the one or more computer-executable instructions, when executed by the at least one processor, further cause the BS to:
transmit first unified TCI state type indication of a type of the first TCI state to the UE; and
transmit second unified TCI state type indication of a type of the second TCI state to the UE,
wherein each of the type of the first TCI state and the type of the second TCI state is one of an UL TCI state and a joint TCI state.

19. The BS of claim 15, wherein:
the first UL power control configuration is associated with at least one of:
the first TCI state,
a first TCI state Identity (ID) of the first TCI state,
a first panel ID associated with the first TRP,
a first cell ID associated with the first TRP,
a first search space ID associated with the first TRP,
a first Control Resource Set (CORESET) ID associated with the first TRP,
a first CORESET pool index associated with the first TRP, or
a first TRP-specific ID associated with the first TRP, and
the second UL power control configuration is associated with at least one of:
the second TCI state,
a second TCI state ID of the second TCI state,
a second panel ID associated with the second TRP,
a second cell ID associated with the second TRP,
a second search space ID associated with the second TRP,
a second CORESET ID associated with the second TRP,
a second CORESET pool index associated with the second TRP, or
a second TRP-specific ID associated with the second TRP.

20. The BS of claim 15, wherein:
the first UL power control configuration comprises at least one of:
a first UL power control ID associated with the first TRP,
a first P0 alpha set configuration for a first Physical Uplink Control Channel (PUCCH) associated with the first TRP,
a second P0 alpha set configuration for a first Physical Uplink Shared Channel (PUSCH) associated with the first TRP, or
a third P0 alpha set configuration for a first Sounding Reference Signal (SRS) associated with the first TRP, and
the second UL power control configuration comprises at least one of:
a second UL power control ID associated with the second TRP,
a fourth P0 alpha set configuration for a second PUCCH associated with the second TRP,
a fifth P0 alpha set configuration for a second PUSCH associated with the second TRP, or
a sixth P0 alpha set configuration for a second SRS associated with the second TRP.
